(19) United States
(12) Patent Application Publication
(10) Pub. No.: US 2014/0377431 A1
(43) Pub. Date: Dec. 25, 2014

(54) SPINNING GRILL APPARATUS AND METHOD

(71) Applicant: Bijan M. Kazerouni, Potomac, MD (US)

(72) Inventor: Bijan M. Kazerouni, Potomac, MD (US)

(21) Appl. No.: 13/924,850

(22) Filed: Jun. 24, 2013

(51) Int. Cl. A47J 37/04; A47J 37/07; A23L 1/01

(52) U.S. Cl. CPC A47J 37/043; A23L 1/0128; A47J 37/0786; A47J 2037/0795
USPC 426/523; 99/443 R; 99/421 R

(57) ABSTRACT

The present invention provides a novel spinning grill in which a container supporting a fire for grilling is caused to rotate in relation to products supported over the grill. The preferred structure includes a novel arrangement of a stand, a spinning container, a mounting component and grilling attachments providing highly advantageous grilling qualities and advantages.

### INTRODUCTION

The present application is a non-provisional of U.S. Ser. No. 61/663,564 to B. Kazerouni, filed on Jun. 23, 2012, the entire disclosure of which is incorporated herein by reference. The present invention provides an improved system for cooking food and, in particular, for grilling food. Among other things, the present invention provides a very interesting, aesthetic and highly utilitarian design that greatly improves grilling of foods. Among other things, the present invention provides a very sleek and aesthetic, compact and non-intrusive structure that be very advantageous in a variety of settings, including within commercial spaces having limited and costly ground space and in which appeal and elegance is advantageous for customer satisfaction. The present invention also provides a highly utilitarian design that provides a very high quality grilling of foods for high end food products. The present invention also provides a novel grill structure that enables high through-put of food products to accommodate large numbers of patrons or guests. While the present invention is highly desirable and advantageous in commercial applications (such as, e.g., for restaurants, caterings, outdoor functions, such as, e.g., fairs, flea markets, tailgating events, etc., the present invention is also highly desirable and advantages in residential applications (such as, e.g., for family cook outs or the like).

### SUMMARY

The present invention provides substantial improvements over existing systems and methods for cooking food products and the like.

According to some illustrative embodiments, A rotating grill, comprising: a stand; a container rotatably supported on the stand, the container being configured to support combustible material for creating a fire to cook food products; a mounting component supported above the container, the mounting component being configured to support a grilling plate above the container upon which food products can be supported and grilled.

In some examples, the mounting component includes a plurality of holes or slots and the grilling surface is supported on the mounting component by fitting a portion of the grilling plate within the holes or slots. In some examples, the plurality of holes or slots are vertically arranged such that the height of the grilling plate above the container can be adjusted. In some examples, the device further includes a tool for grasping the grilling plate. In some examples, the rotating grill includes a plurality of the grilling plates. In some examples, the grilling plates are generally pie shaped and, preferably, there are six of the grilling plates. In some examples, the container is rotatably supported on the stand via a bearing. In some examples, the container includes a lower compartment within which the bearing is located that is beneath a fire supporting surface of the container. In some examples, the container includes holes and vanes configured to draw air into the container upon rotation of the container such as to enhance oxygenation and combustion within the container. In some examples, the device includes a handle for manually spinning the container on the bearings. In some examples, the bearings are configured such that upon manual spinning of the container, the container spins for at least about 1 minute before coming to rest or, even preferably, for at least about 2 minutes before coming to rest. In some examples, the device includes a human powered mechanism for spinning the container, which can include, e.g., a foot pedal, a hand crank and/or other mechanism for imparting human power. In some examples, the device includes a motor for causing rotation of the cylinder. In some examples, the motor is electric, gas or heat powered. In some examples, the mounting component is manually rotatable to a new location so as to adjust the angular position of the grilling plate over the cylinder to facilitate operation and use of the rotating grill. In some examples, the device includes a plurality of attachments that are attachable to the mounting plate and, preferably, the attachments include one or more of the following: a) a skewer; and b) a rotatable basket. In some examples, the container, the mounting component and the grilling plate are made of stainless steel and, preferably, the container, the mounting component and the grilling plate are all made of stainless steel and are all cut from a single sheet of stainless steel during fabrication.

According to some other embodiments, a method of grilling food using a rotating grill is performed that includes: rotating a container supporting combustible material creating a fire to cook food products; and having a mounting component support a grilling plate above the container upon which food products are supported and grilled.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by a way of example, and not limitation, in the accompanying figures, in which:

FIG. 1 is a perspective view of a spinning grill according to a first illustrative embodiment;

FIG. 2 is a diagram showing components of a Container component according to some illustrative embodiments;

FIG. 3 is a diagram showing assembly of a Main Shaft to an ash deflector and a threaded element according to some illustrative embodiments;

FIG. 4 is a diagram showing illustrative outer and inner hexagon Mounting Post components according to some illustrative embodiments;

FIG. 5 is a diagram showing illustrative attachments mountable upon the Mounting Post including an illustrative flipper attachment used as, e.g., a grilling surface and an illustrative chicken or the like skewer attachment according to some illustrative embodiments;

FIG. 6 is a diagram showing another illustrative attachment mountable upon the Mounting Post that involves an illustrative cooking cylinder structure for cooking of vegetables or the like;

FIG. 7 is an illustrative embodiment depicting a single metal sheet that can be employed for fabrication of the spinning grill with the various component parts drawn in a nested relationship prior to separation (such as, e.g., by laser cutting) and fabrication of the component parts from the single metal sheet;

FIGS. 8-12 are illustrative architectural specification sheets depicting illustrative parts according to some illustrative embodiments (note: the parts illustrate the components in a state as cut from a flat metal sheet in accordance with some embodiments—i.e., prior to folding and/or welding as may be employed for certain parts);

FIGS. 13 and 14 are other illustrative embodiments depicting a single metal sheet that can be employed for fabrication of the spinning grill with the various component parts drawn in a nested relationship prior to separation (such as, e.g., by laser cutting) and fabrication of the component parts from the single metal sheet;

FIG. 15 is an elevational view of an exemplary spinning grill according to some illustrative embodiments, shown with attachments supported on a Mounting Post;

FIG. 16 is an elevational view of the exemplary spinning grill shown in FIG. 15 shown with flipper attachments providing a grilling surface closer to the grill;

FIG. 17 is an elevational view of the exemplary spinning grill shown in FIG. 15 shown with the Mounting Post removed so as to expose the Main Shaft;

FIG. 18 is an elevational view of the exemplary spinning grill shown in FIG. 15 shown with other illustrative attachments supported on the Mounting Post;

FIGS. 19A and 19B are elevational and side views, respectively, of a Container according to some illustrative embodiments of the invention;

FIGS. 20-29 depict illustrative designs of the component parts (see Item Nos. 1-15 in FIG. 19A) of the Container shown in FIGS. 19A and 19B;

FIG. 30 is an elevational diagram showing a Stand connected to a Main Shaft according to some illustrative embodiments;

FIGS. 31-36 depict illustrative designs of the component parts (see Item Nos. 1-12 in FIG. 30) of the Main Shaft and the Stand shown in FIG. 30;

FIG. 37 is an elevational view of the Mounting Post outer sleeve (larger hexagonal sleeve at the left side of the figure) and inner hexagonal sleeve (smaller hexagonal sleeve at the right side of the figure) according to some illustrative embodiments;

FIGS. 38-43 depict illustrative designs of the component parts (see Item Nos. 1-6 in FIG. 37) of the Mounting Post shown in FIG. 37;

FIG. 44 is a diagram showing a top view and a front end view of an illustrative flipper attachment according to some illustrative embodiments of the invention;

FIG. 45 is a diagram showing the construction of an exemplary removal handle for removal and/or placement of a flipper or the like attachment on the Mounting Post (i.e., the illustrated embodiment including two parts that are attached (e.g., welded) together to form the unitary structure shown at the bottom of the figure;

FIG. 46 is a diagram showing the construction of a basket cylinder attachment according to some illustrative embodiments;

FIGS. 47-50 depict illustrative designs of the component parts (see Item Nos. 1-5 in FIG. 46) of the basket cylinder attachment shown in FIG. 46;

FIG. 51 is a conceptual diagram showing air and heat flow according to some illustrative embodiments of the invention;

FIGS. 52-53 is a diagram depicting alternate methods of rotating the Cylinder component in some alternative embodiments, including a human powered pedal mechanism, a motor (e.g., electric or gas powered motor), and a heat powered motor (e.g., employing the heat of the fire within the Cylinder to rotate the Cylinder) such as, e.g., a Stirling Engine;

FIG. 54 is an illustrative cross sectional side view of a grill device according to some embodiments of the invention, with components within the stand and Container depicted, including, e.g., bearings and other parts; and

FIG. 55 is an illustrative diagram showing mounting of the bearing according to some illustrative embodiments of the invention.

### DETAILED DISCUSSION OF SOME ILLUSTRATIVE EMBODIMENTS

While the present invention may be embodied in many different forms, the illustrative embodiments are described herein with the understanding that the present disclosure is to be considered as providing examples of the principles of the invention and that such examples are not intended to limit the invention to preferred embodiments described herein and/or illustrated herein.

In some illustrative and non-limiting embodiments a spinning barbeque grill is provided. In the preferred embodiments, the spinning grill includes three (4) main components, including a main Container, a Stand, and a Main Shaft, and a Mounting Component along with a plurality of attachments. As described below, the attachments are releasable connectable to the Mounting Component.

Container:

According to the preferred embodiments, the first main component is the Container. In the preferred embodiments, the Container supports the heat source, such as, e.g., a fire, and is supported to spin during use. In some preferred embodiments, the fire is a natural source fire, such as, e.g., a wood burning fire or, less preferably, a coal burning fire. In the preferred embodiments, the Container is made of metal, preferably steel. In the most preferred embodiments, the Container is made of stainless steel. Notably, the stainless steel differs from carbon steel by the amount of chromium present. In some preferred embodiments, the stainless steel employed is a grade 304 stainless steel.

In some illustrative examples, illustrative composition ranges for grade 304 stainless steel can include (as set forth at AZOM.COM's A to Z of Materials):

| Grade | | C | Mn | Si | P | S | Cr | Mo | Ni | N |
|---|---|---|---|---|---|---|---|---|---|---|
| 304 | min. | — | — | — | — | — | 18.0 | — | 8.0 | — |
| | max. | 0.08 | 2.0 | 0.75 | 0.045 | 0.030 | 20.0 | | 10.5 | 0.10 |

In some illustrative examples, illustrative mechanical properties for grade 304 stainless steel can include (as set forth at AZOM.COM's A to Z of Materials):

| | | Yield | | Hardness | |
|---|---|---|---|---|---|
| | Tensile | Strength | | Rockwell | Brinell |
| | Strength | 0.2% Proof | Elongation (% | B (HR B) | (HB) |
| Grade | (MPa) min | (MPa) min | in 50 mm) min | max | max |
| 304 | 515 | 205 | 40 | 92 | 201 |

While the preferred embodiments are made with stainless steel, in some other embodiments, the Container can be made of other metals (such as, e.g., aluminum, cast iron, etc.), of ceramic or a ceramic coated metals, of porcelain and/or of other suitable materials.

Stand:

According to the preferred embodiments, a second main component is the Stand. In the preferred embodiments, the Stand is configured to support the above-discussed Container and the other components of the spinning grill. In the preferred embodiments, the stand is configured to be connected to the Main Shaft component (discussed below) and to rotationally support the Container component (discussed above). In the preferred embodiments, the Stand connects to the Main Shaft using a simple and easy mechanical connection, such as, e.g., to connect via a threaded end such as to combine and solidify all components with a simple lock washer and wing nut.

In some illustrative and non-limiting examples, the Stand has a tripod configuration with three stabilization legs. In some preferred embodiments, the three stabilization legs are welded together via plurality of different size and shape disks. In the preferred embodiments, the disks are keyed and slotted to accommodate tabs on the legs that align and retain the stands shape. In the preferred embodiments, the Stand is similarly made of metal, preferably steel. In the most preferred embodiments, the Stand is made of stainless steel. In some preferred embodiments, the stainless steel employed is a grade 304 stainless steel. While the preferred embodiments are made with stainless steel, in some other embodiments, the Stand can be made of other metals (such as, e.g., aluminum, cast iron, etc.), of ceramic or a ceramic coated metals, of porcelain and/or of other suitable materials.

Main Shaft:

According to the preferred embodiments, a third main component is the Main Shaft. In the preferred embodiments, the Main Shaft passes through the Container and is supported upon the top of the Stand. In the preferred embodiments, the Container is supported so as to rotate around the Main Shaft, while the Main Shaft remains stationarily fixed in position. In some preferred embodiments, the Main Shaft can be made with stainless steel or can be made of other metals (such as, e.g., aluminum, cast iron, etc.), of ceramic or a ceramic coated metals, of porcelain and/or of other suitable materials.

Mounting Component:

According to the preferred embodiments, a fourth main component is the Mounting Component. In the preferred embodiments, the Mounting Component is supported upon the Main Shaft and includes an array of slots, holes and/or channels to enable the removable connection of Attachments, such as, e.g., grilling surfaces (e.g., flippers), grilling baskets, skewers and/or the like (discussed below). In the preferred embodiments, the Mounting Component can be rotated around the Main Shaft in order to change the angular position of the attachments upon the Mounting Component to facilitate use during grilling.

In the preferred embodiments, the Mounting Component is similarly made of metal, preferably steel. In the most preferred embodiments, the Stand is made of stainless steel. In some preferred embodiments, the stainless steel employed is a grade 304 stainless steel. While the preferred embodiments are made with stainless steel, in some other embodiments, the Mounting Component can be made of other metals (such as, e.g., aluminum, cast iron, etc.), of ceramic or a ceramic coated metals, of porcelain and/or of other suitable materials.

Operation:

In summary, in the preferred embodiments, a fire source is placed within the Cylinder (preferably, natural wood). The wood is ignited using a suitable means, such as, e.g., a match or lighter and the Cylinder is then caused to spin. In the preferred embodiments, the Cylinder is manually spun by a user rotating the Cylinder using a handle. In the preferred embodiments, the rotation of the Cylinder will cause air to be drawn upward through air passages in a manner to oxygenate the fire, resulting in enhanced fire creating and sustaining qualities.

During rotation of the fire, the heat will be more evenly distributed in the vicinity above the Cylinder due to the rotation of the heat source. As a result, a greatly improved grilled product will be achieved. Among other things, the present invention enables improved grilling of meats, fish, poultry and the like, as well as the improved grilling of vegetables and the like.

### Further Details of Some Exemplary Embodiments

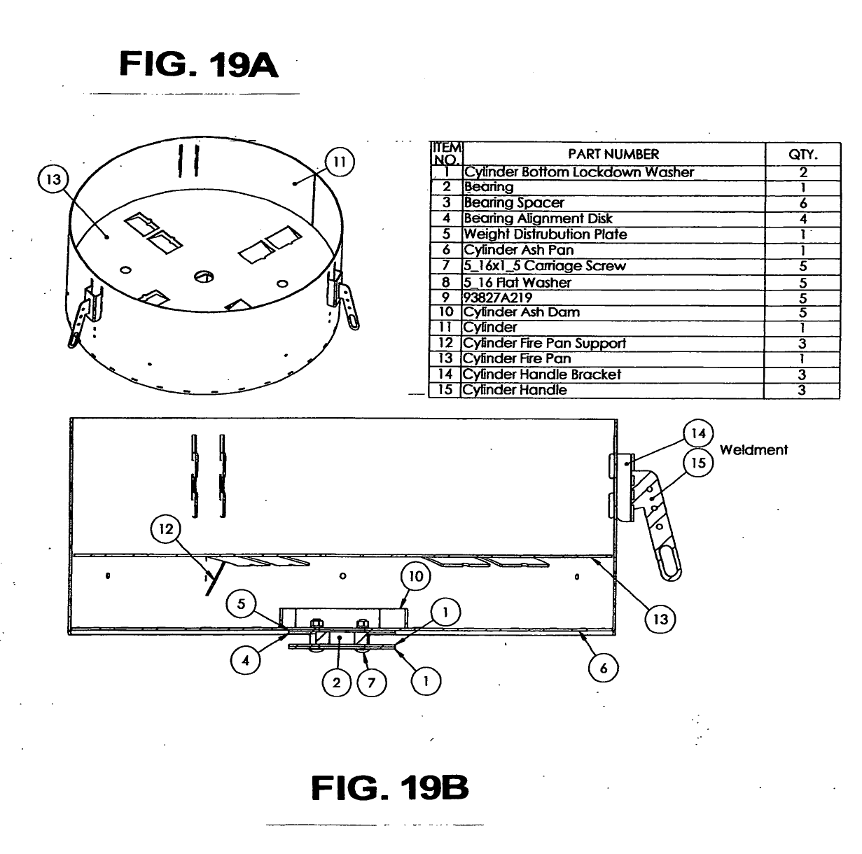

In some exemplary embodiments, the Container can be constructed as shown in, e.g., FIGS. 19A and 19B. As shown, the Container (also referred to as a Cylinder or Fire Cylinder herein) includes a lower section having a bottom plate or ash pan disk 6, a rolled cylinder plate 11 that surrounds the disk 6, a cylinder fire pan 13 upon which the combustible material (e.g., wood) is supported, a bearing 2, fire pan support members 12, a cylinder ash dam 10 that extends annularly around the bearing so as to help prevent ashes from entering the bearing, a lockdown washer 1, a bearing adjustment disc 4, bearing spacers, screws 7 and handles 15 that are supported on handle brackets.

The bearing 2 includes a plurality of ball bearings contained within a grease-filled enclosure as is known in the art and allows for the Container to spin around its central axis.

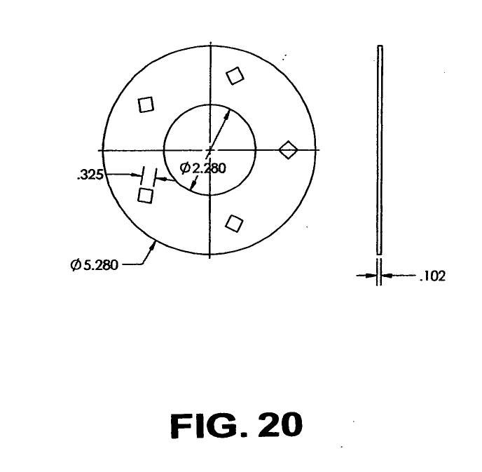

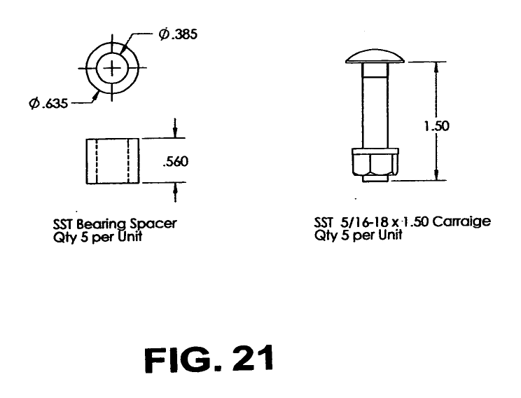

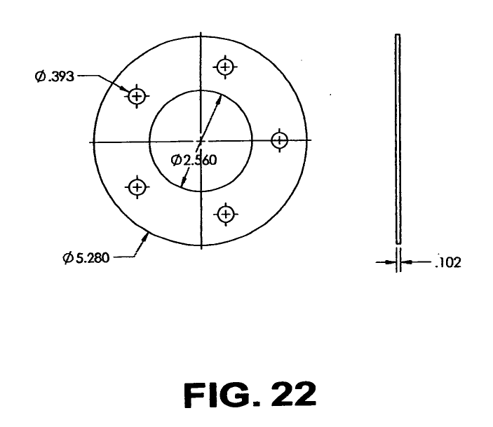

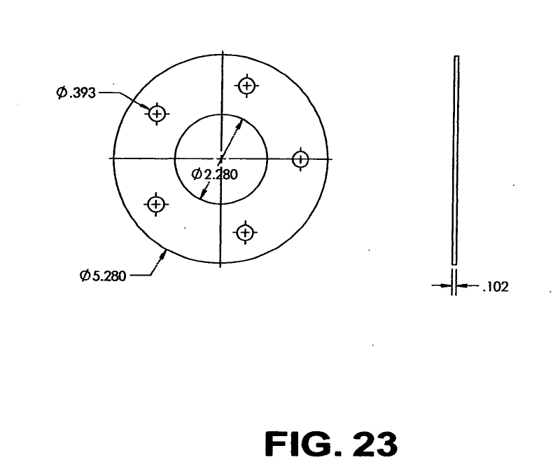

The bearing 2 is held against the bottom of the ash pan with the above-noted assortment of spacers and disks. As shown in, e.g. FIGS. 20 and 22-24, the disks have an array of holes that receive the screws in such a manner to allow mounting and/or replacement of the bearing 2.

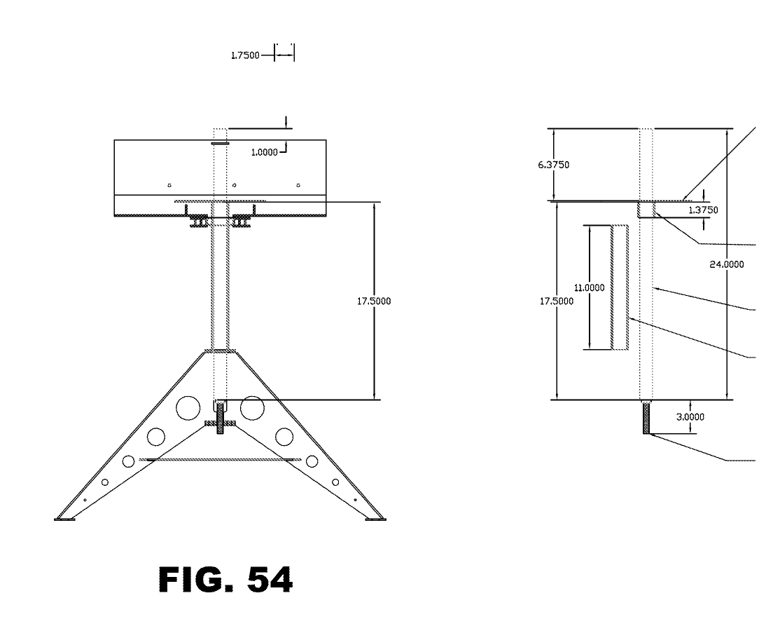

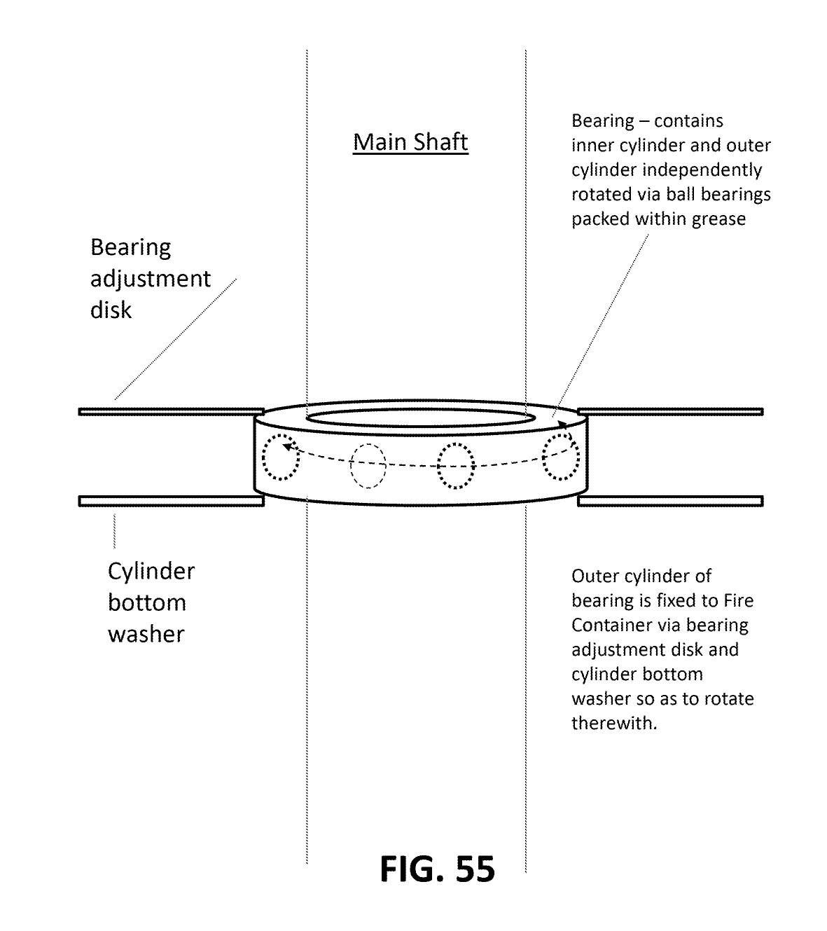

With reference to FIGS. 54 and 55, the bearing includes, in some illustrative embodiments, an annular cylinder shaped member with inner and outer cylinders that move independently of one another via grease packed ball bearings. While this is one illustrative form of bearing, it should be appreciated that other known bearings can be employed by those in the art as desired based on circumstances.

In the preferred embodiments, the bearing 2 is mounted in a manner that when fuel is burned on top of the fire pan 13, within the cylinder, the bearing is located beneath a separate compartment under the fire pan 13. In addition, the device is preferably constructed such that air convection is achieved in a manner to acts as a cooling agent that further preserves the bearing 2 from heat that may be imparted to the bearing 2, such as, e.g., due to radiation from the fire pan and/or induction through the main shaft. In the preferred embodiments, the distance between the ash pan 6 and the fire pan 13 is a few inches, and in the preferred embodiments about 4 inches. In the preferred embodiments, the outer perimeter of the cylinder 11 includes holes for allowing air flow to enter under the fire pan 13. In some embodiments, the vicinity of the bearing 2 can also include sufficient air passage openings (such as, e.g., around the bearing 2) such as to allow air to enter the bottom space between the ash pan 6 and the fire pan. By allowing air to enter the Container beneath the fire pan 13, air can further pass upwards via the openings in the bottom of the fire pan. In this manner, when the fire pan is rotated and a when a fire is created above the fire pan, convective air flow can pass proximate the bearing 2 and up through the openings in the fire pan. Notably, the openings in the fire pan preferably include angled plates or fins as shown, and preferably such plates or fins will increase convective airflow upward into the container. For example, the container shown in FIG. 19A is preferably rotated in a clockwise direction to enhance convective flow. As discussed above, this convective flow can also enhance combustion and oxygenation qualities of the grill.

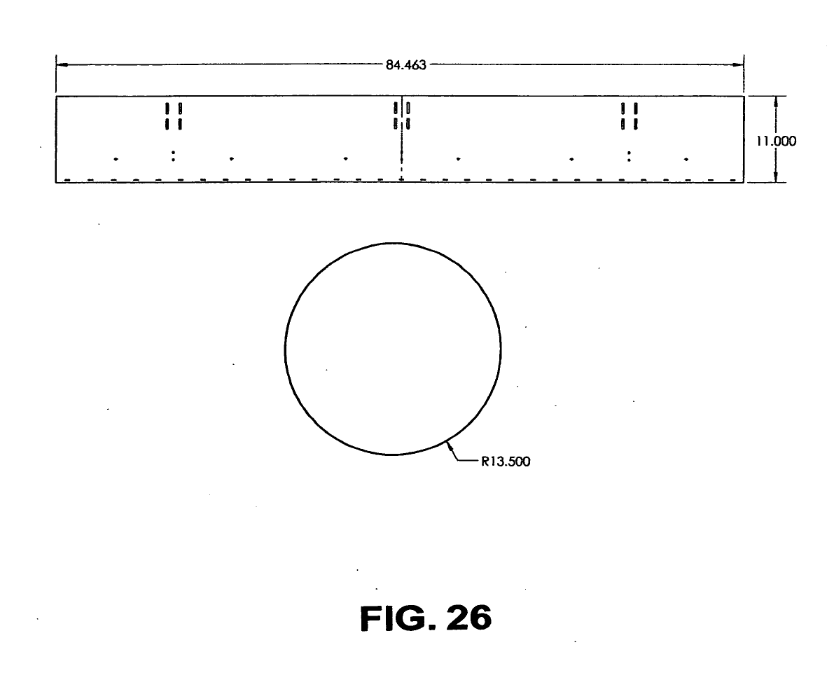

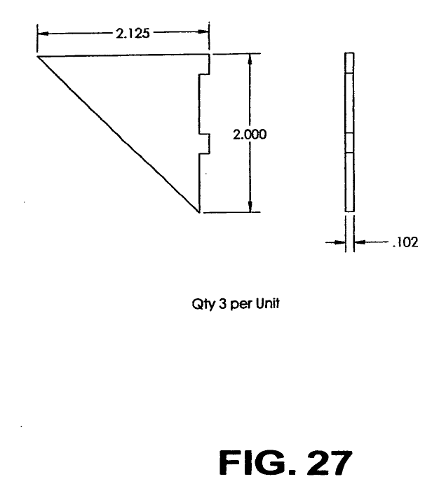

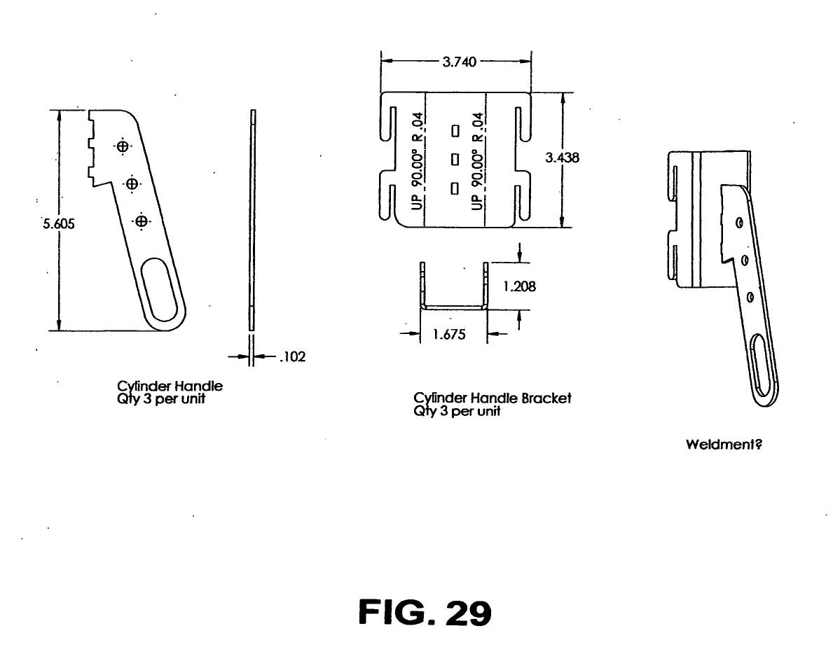

As shown in FIGS. 19A, 19B, 26, 27, and 29, the cylinder of the Container also includes slots for receiving projections of the supports (FIG. 27) and of the handles (FIG. 29) to facilitate assembly and welding of the parts together. The supports shown in FIG. 27 help to support the fire pan, while the handles shown in FIG. 29 are used for manually rotating the cylinder in the preferred embodiments.

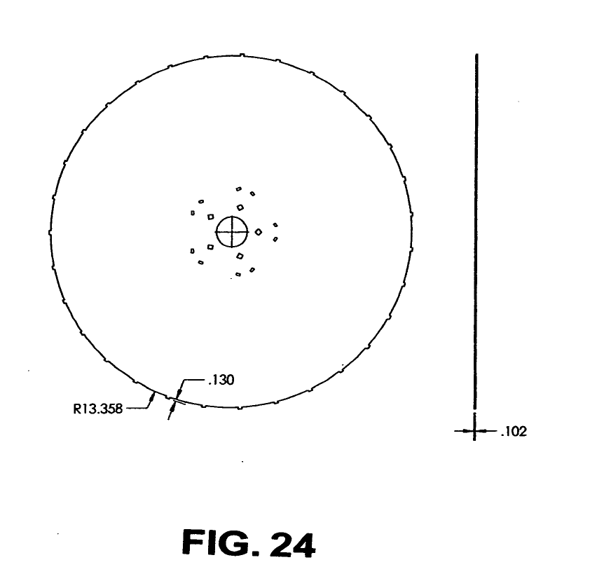

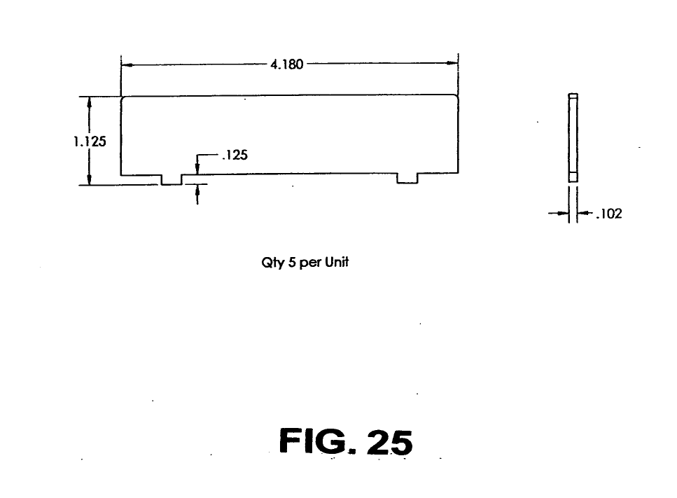

As shown in FIG. 19B, the dam 10 is welded to the ash pan so as to surround the bearing to form a barrier or a dam preventing any ashes that my fall through the fire pan from entering the side and falling into the bearing opening. As shown in FIG. 25, the dam can be made of a plurality of sheets that are bent and welded to the ash pan 6 shown in FIG. 24, such as, e.g., by alignment of tabs on the dam parts with the outer array of holes shown in FIG. 24 and welding the same thereto.

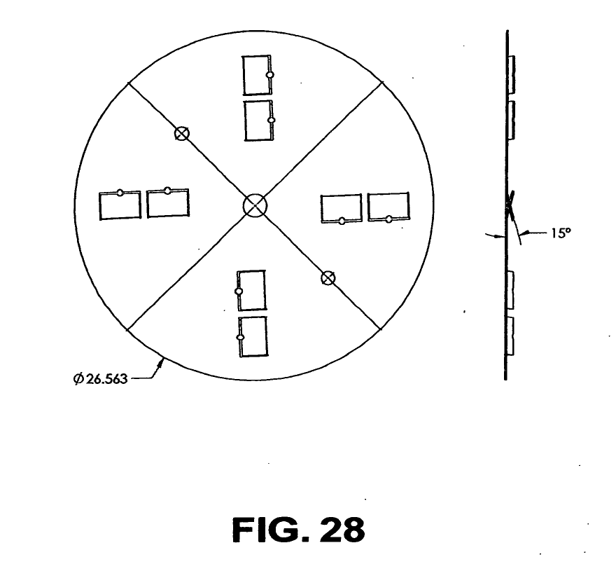

As best shown in FIGS. 19A, 19B, and 28, the fire pan is a large disk that supports the combustible fuel, which can include wood, charcoal and/or any other medium suitable and non-toxic to produce enough heat (i.e., British Thermal Units (BTUs) to cook food. The fire pan 13 is preferably supported so as to removably rest upon the fire pan supports (discussed above) located and attached to the main cylinder. As shown in the figures, a clearance hole is provided in the center of the fire pan disk in order to allow it to spin freely without frictionally engaging the main shaft. In order to clean or to otherwise access the bottom of the container beneath the fire pan 13, a user can manually grasp and remove the fire pan 13 via the two finger holes located symmetrically on opposite side of the fire pan. In addition, as discussed above, the fire pan also includes plates or fins that act as louvers that are located in an array within the disk. When the Container is spun (such as, e.g., by a user manually rotating the Container via the handles the fire pan disk moves with cylinder and the louvers assist in gathering air like a scoop or fan such as to further fuel the fire with prevalent oxygen.

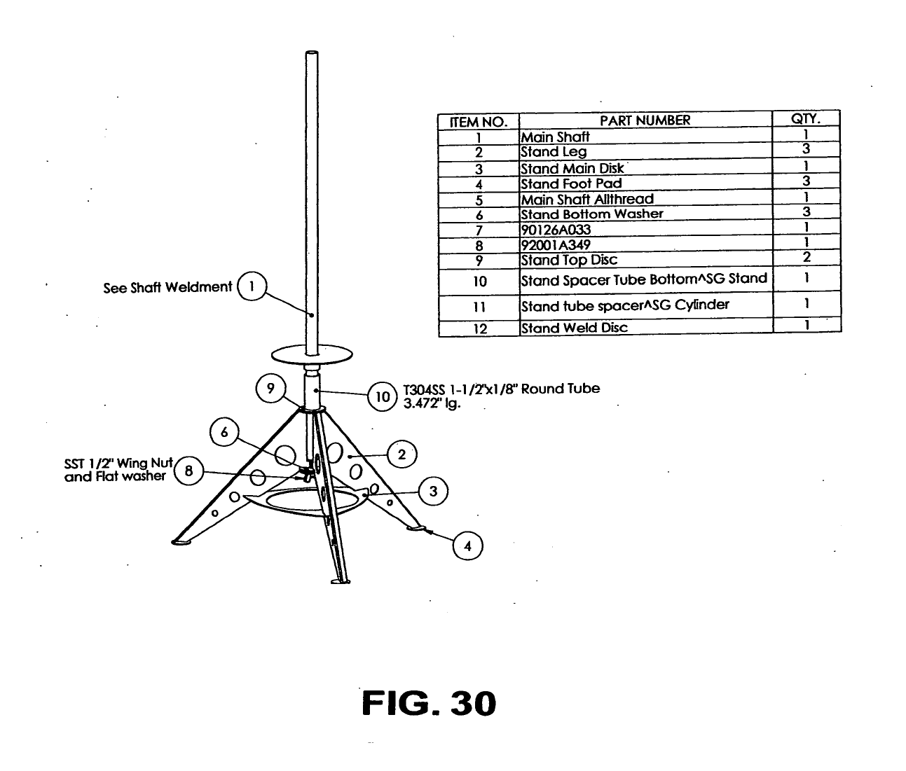

In the preferred embodiments, the Main Shaft also includes an ash deflector disk mounted thereon that works in conjunction to the dam to prevent ashes from entering the bearing (i.e., which ashes may fall due to the spacing between the fire pan and the Main Shaft. The ash deflector disk can be seen, e.g., in FIG. 30 proximate a lower end of the Main Shaft 1, and above the stand spacer tube 10 of that illustrative example. With the Container mounted on the Stand, the deflector disk resides slightly above the protective dams and is stationary, while the dams rotate with the Container underneath the deflector. The gap between the ash deflector disk and the dams allow the continuation of airflow that is drawn from under the grill, through the bearing, between the dams and deflector and to the rest of the grill.

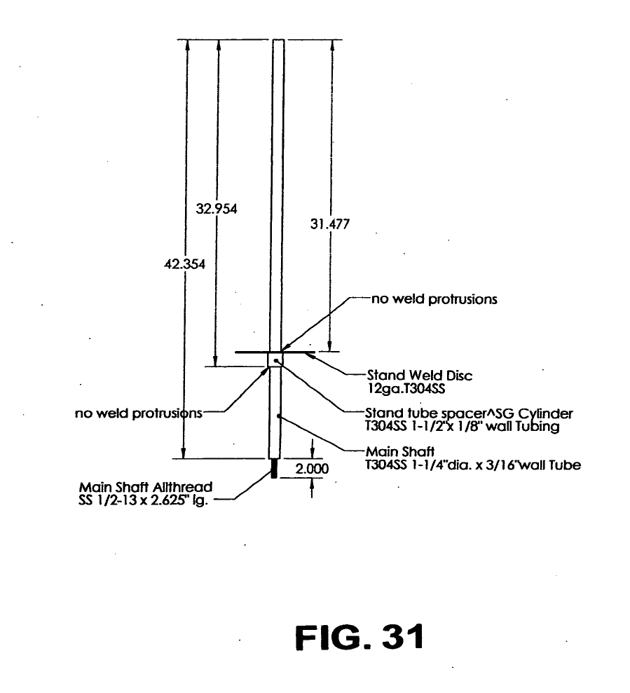

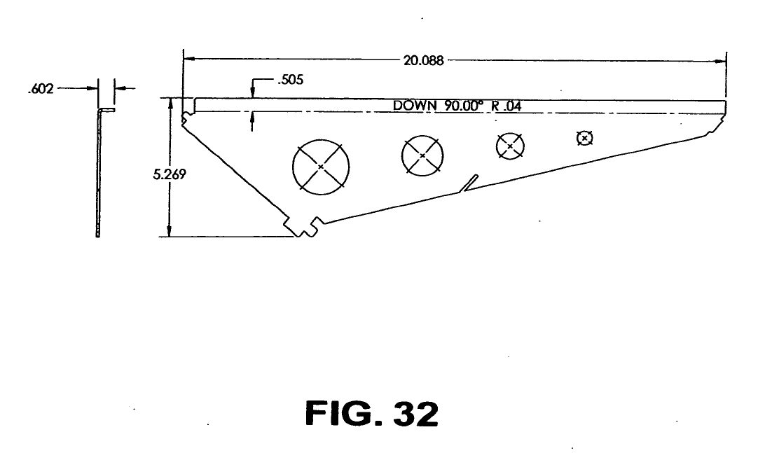

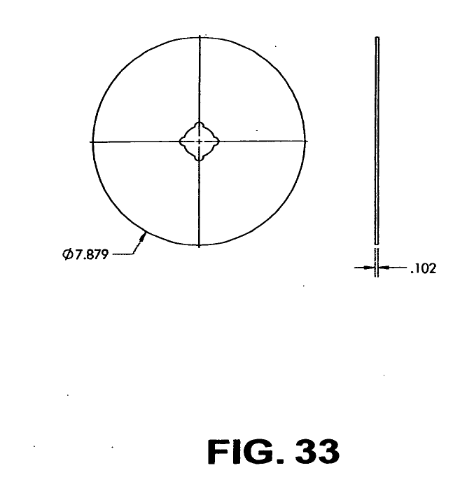

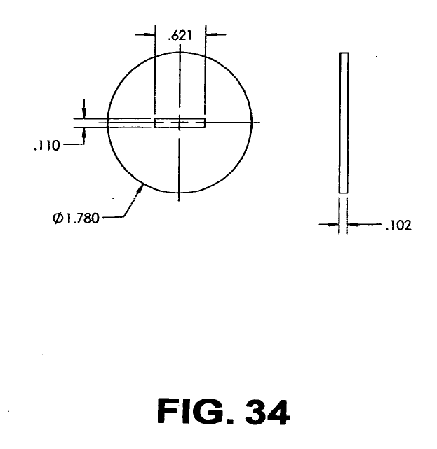

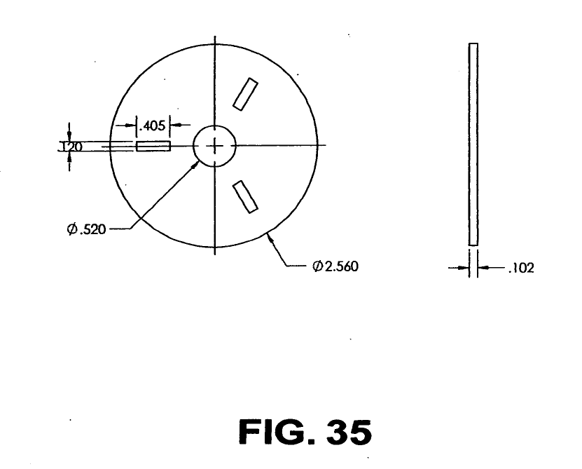

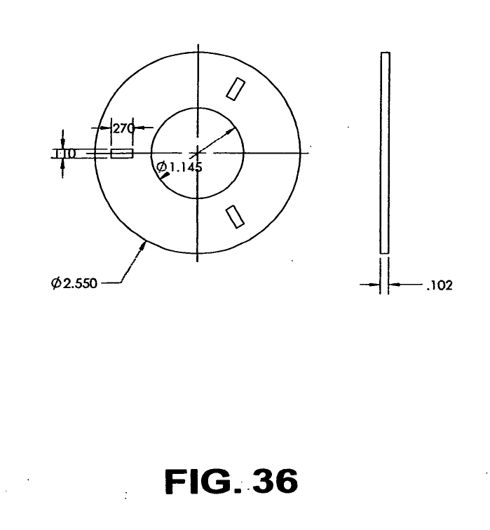

With reference to FIGS. 30 and 31, the Main Shaft 1 is preferably configured so as to extend through central holes within the disks of the Stand (such as, e.g., top disk 9 and bottom washer 6 shown in FIG. 30). As illustrated, the bottom of shaft is formed with a threaded end that penetrates the bottom of the Stand through the series of disks/washers. In order to retain the shaft upon the Stand, as shown in FIG. 30 a wing nut 8 or the like is preferably threadedly engaged with these threads so as to fix the Main Shaft to the Stand.

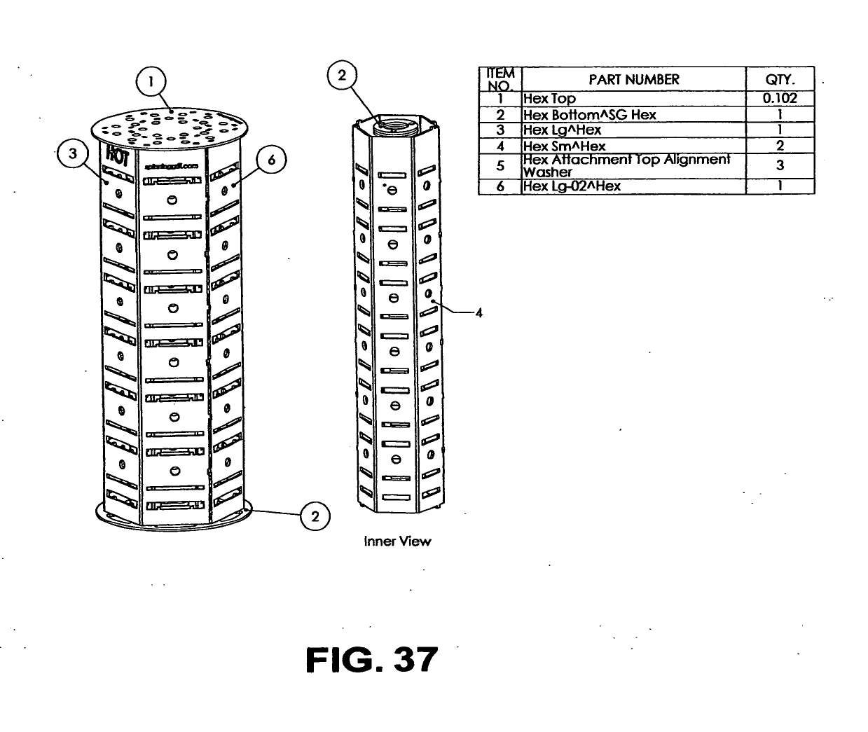

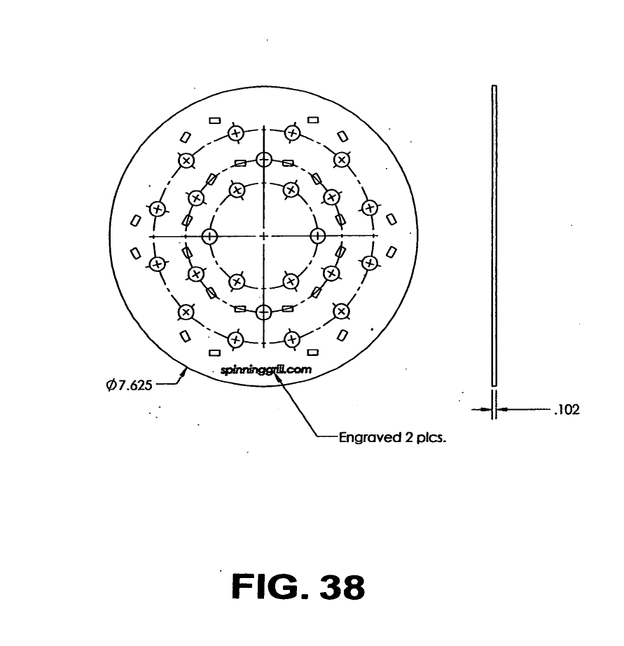

With reference to FIG. 37, the Mounting Component preferably includes outer and inner sleeve members. In the illustrative example, the outer and inner sleeve members are both hexagonal in shape. As shown, the flat faces of each side of such hexagons are provided with an array of receiving slots and receiving holes for releasably attaching attachments. In the preferred embodiments, inner and outer sleeves are provided in order to increase mounting stability of the attachments thereto. In that regard, the arrays of holes and slots in the inner and outer sleeves are formed so as to be in alignment to receive extensions from the attachments in both sleeves concurrently for stability.

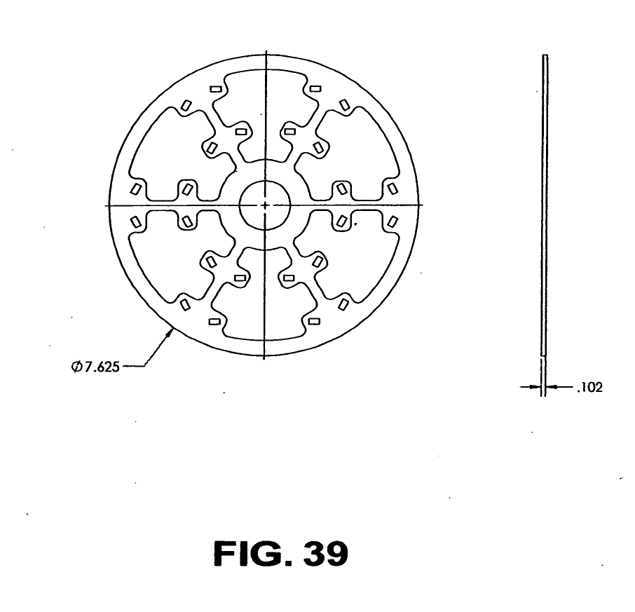

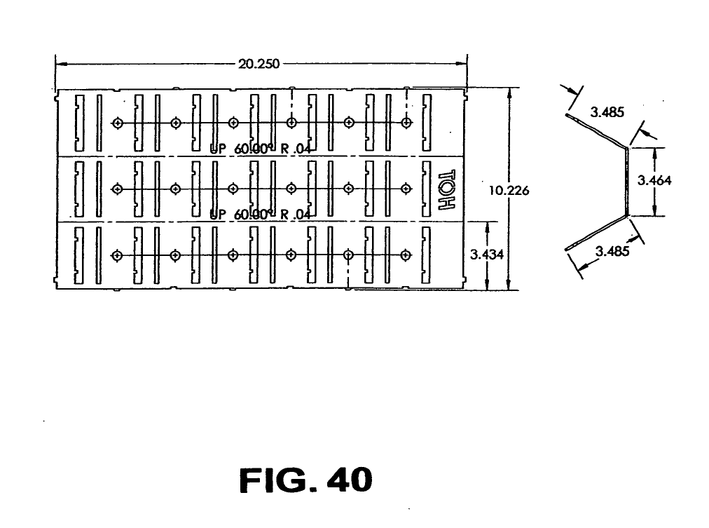

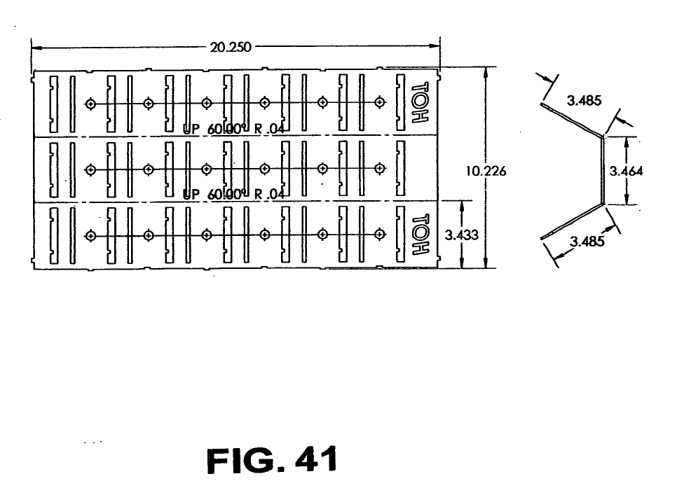

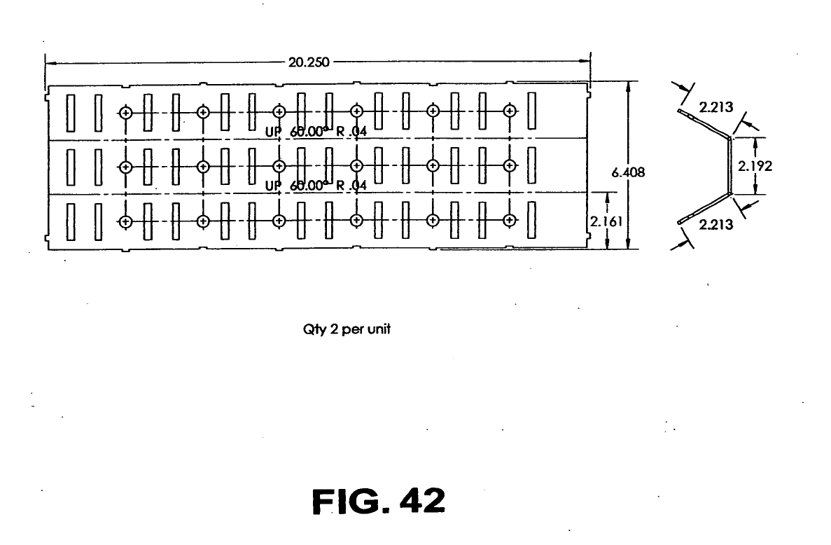

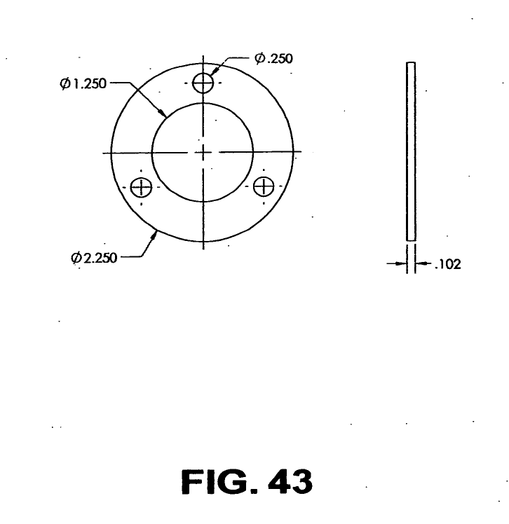

In the preferred embodiments, the Hexagonal sleeves are fixed together via top and bottom circular plates 1 and 2 to which both hexagonal sleeves are welded. In the preferred embodiments, the bottom circular plate has a central opening as best shown in FIG. 39 that can receive the Main Shaft 1. In assembly, the Mounting Component parts are welded together and the unified Mounting Component is slid over the top of the Main Shaft 1, with the central opening of the bottom plate 2 receiving the Main Shaft and the center of the top plate 1 resting on top of the Main Shaft 1. In this manner, the Mounting Component is well supported on the Main Shaft and is concurrently able to be rotated around the Main Shaft such as to enable a user to freely adjust the angular position of the Mounting Component with respect to the Main Shaft during use.

In the preferred embodiments, the Mounting Component is configured so as to provide six sections for mounting attachments. While other embodiments are possible, including, e.g., three, four or five sections, or even seven or eight sections, in the most preferred embodiments a hexagonal arrangement is provided. In the preferred embodiments, a variety of attachments Standard with the grill is a hexagonal attachment allowing six sides of grilling utilizing different slots and holes that accommodate different cooking attachments. Desired heat and temperatures are achieved by changing elevations for each cooking attachment.

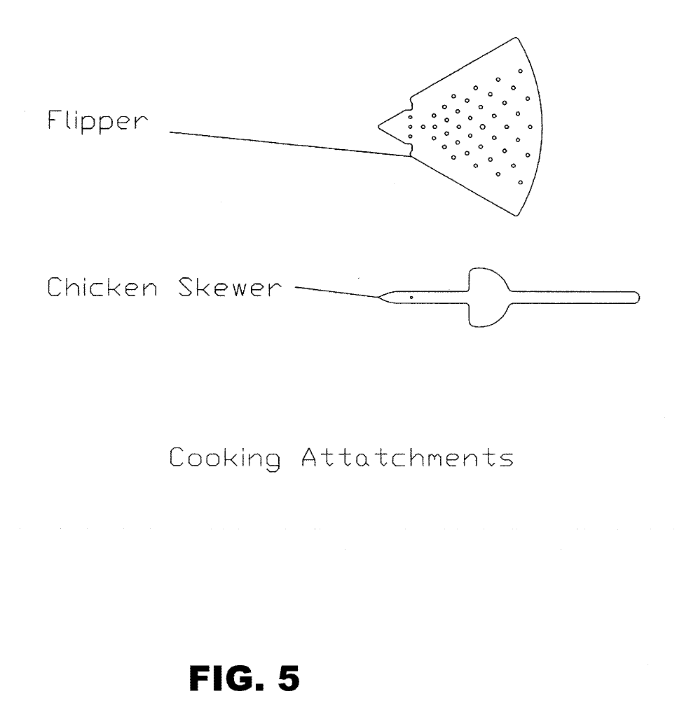

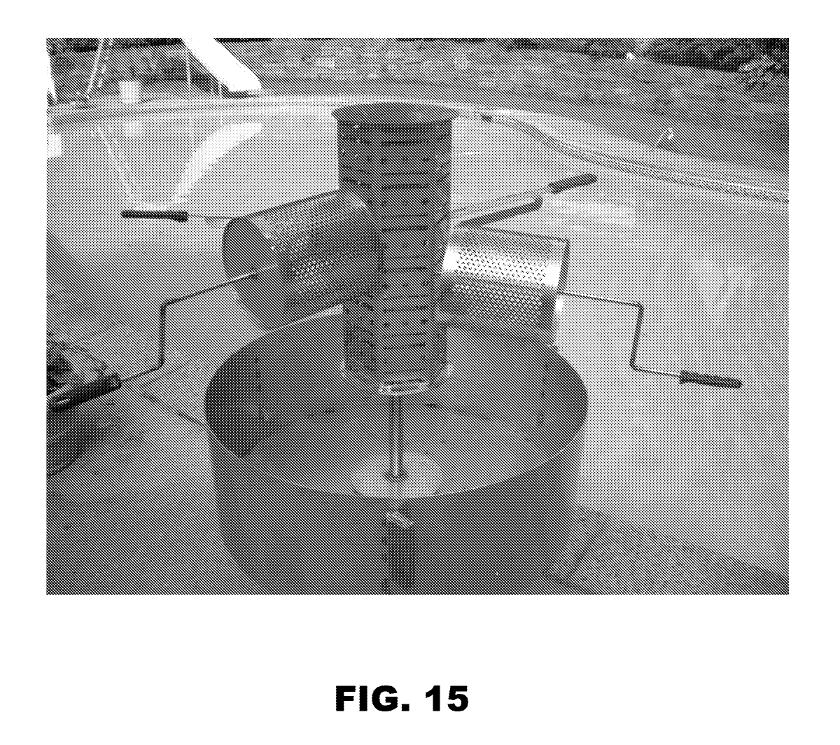

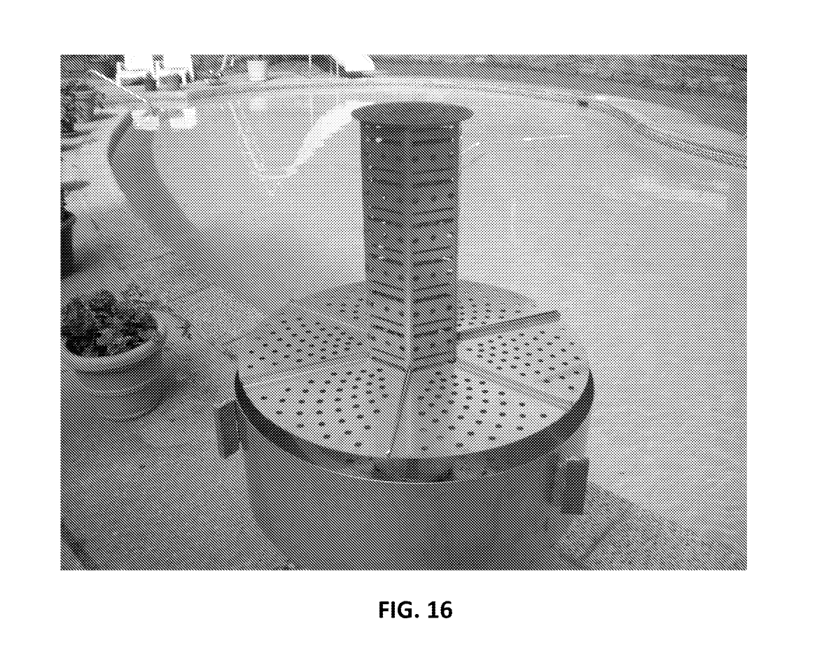

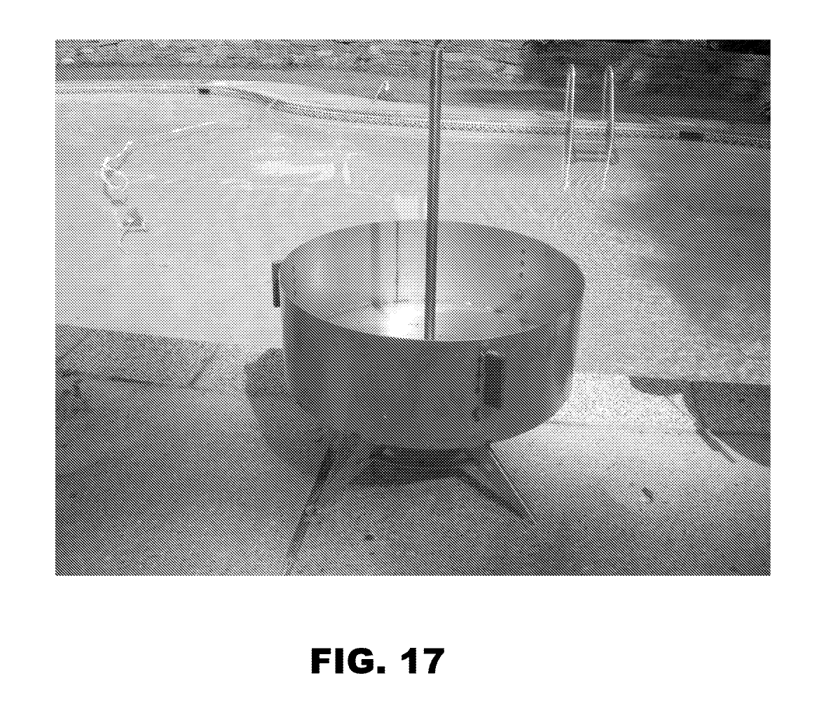

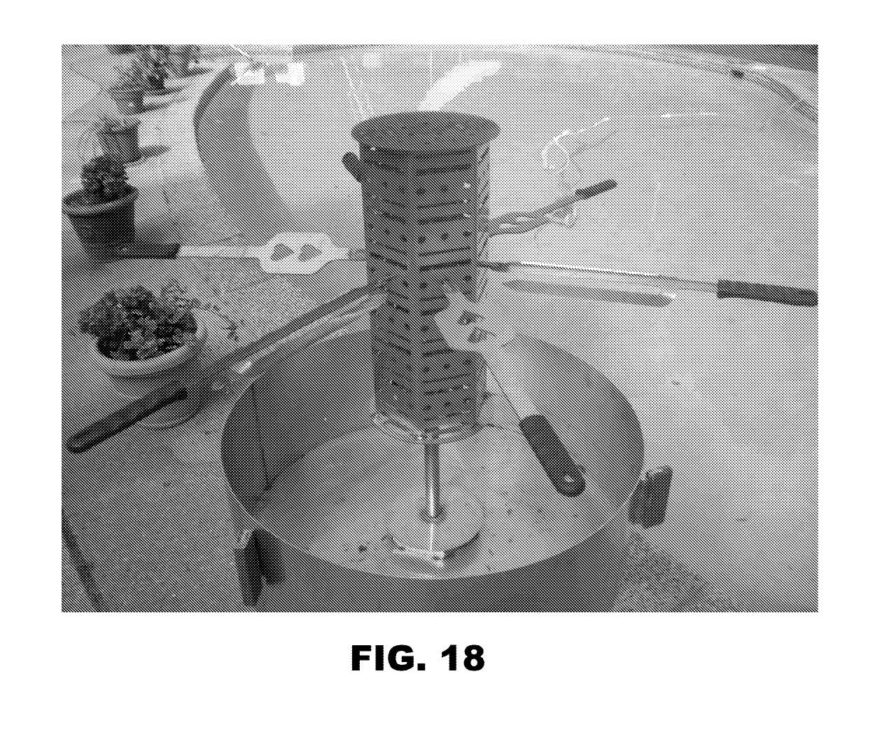

In some illustrative embodiments, a preferred type of attachment involves a “skewer” attachment. In the preferred embodiments, the skewers can be configured as shown in, e.g., FIG. 5 (chicken and the like skewer shown and labeled), FIG. 15 (two skewers shown mounted to the Mounting Component at the backside thereof), FIG. 18 (six skewers shown mounted to the Mounting Component along each of the six sides of the hexagonal structure). In the preferred embodiments, the skewers include a generally flat blade like structured that tapers at the end as shown in FIG. 5, and which can be readily received within and supported within the slots of the hexagonal Mounting Component as shown. It should be appreciated that the skewers can also be raised and lowered by placement at different slots in order to move the cooked items closer or further from the heat of the fire container. For example, during use, after the item (such as, e.g., chicken upon the skewer) is fully cooked at a lower height, the user can raise the skewer and place the item (e.g., chicken) at a higher level to maintain the product warm without overcooking Among other things, this can facilitate cooking of a plurality of items (such as, e.g., a plurality of chickens) which can be cooked in succession and raised to a higher warming region while other items are being cooked. This can, e.g., facilitate cooking production of a large quantity of items using the grill.

In the preferred embodiments, different types of skewers can be provided, which can be used for various foods, such as, e.g., meats (beef, pork, chicken, etc.), vegetables and/or any cooking food product that can be skewered. In some embodiments, skewers can consist of tubular spear-like members that can be supported within the circular openings, rather than within the slots. By way of example, such tubular spear-like members can be used for making kabobs or the like, such as, e.g., with smaller chunks of meat supported along the spear-like skewer. In some embodiments, a plurality of users can stand around respective sides of the hexagonal Mounting Component and raising and/or lowering their respective skewers to cook their own kabob or the like to their liking.

As indicated, in some embodiments a novel custom shaped chicken and the like skewer I provided as shown in the FIGS. For reference, two illustrative custom shaped skewers are shown in FIG. 18. A first custom skewer includes a central longer blade that extends into a slot of the hexagonal Mounting Component, and two parallel blades that extend along side left and right sides of the central longer blade. A second custom skewer includes a similar central long blade that extends into a slot of the hexagonal Mounting Component, and includes a central widened region. In the preferred embodiments, the custom skewers can inserted into an average size whole chicken. In this manner, a whole chicken can be mounted above the grill for cooking Moreover, as these custom skewers are flat, the whole chicken can be readily turned over in order to allow cooking both sides of chicken. Additionally, this custom skewer also enables the skewer to be used to brown both sides of a chicken or the like before removing a whole chicken from the custom skewer, and cutting the chicken or the like (e.g., in half) and finishing grilling of the chicken or the like (e.g., the fresh exposed portions) upon a grill plate such as, e.g., a flipper as shown in FIG. 5 above an illustrative custom skewer.

Additionally, it is noted that tubular skewers that are supported within the circular holes of the Mounting Component can be advantageously rotated (e.g., manually) in their supported positions such as to, e.g., enable the skewered food items to be rotated above the fire container (i.e., rotated around the central axis of the spear-like skewer).

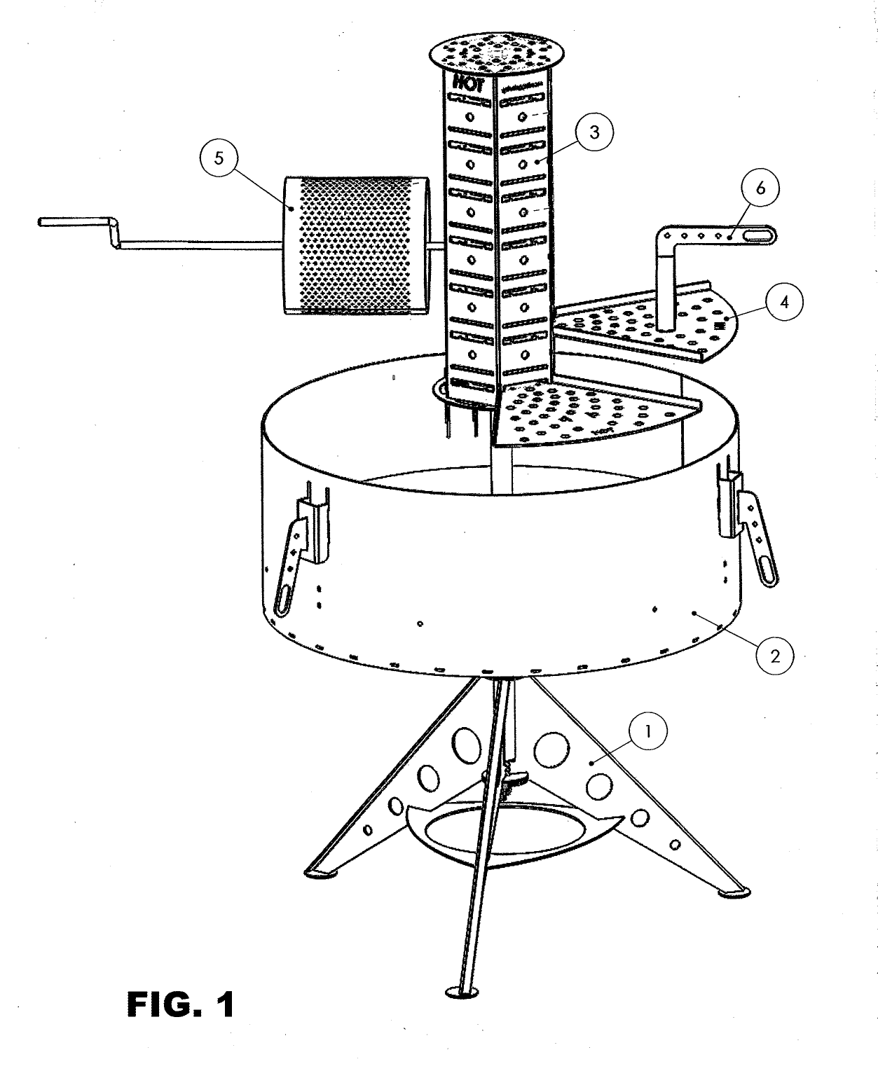

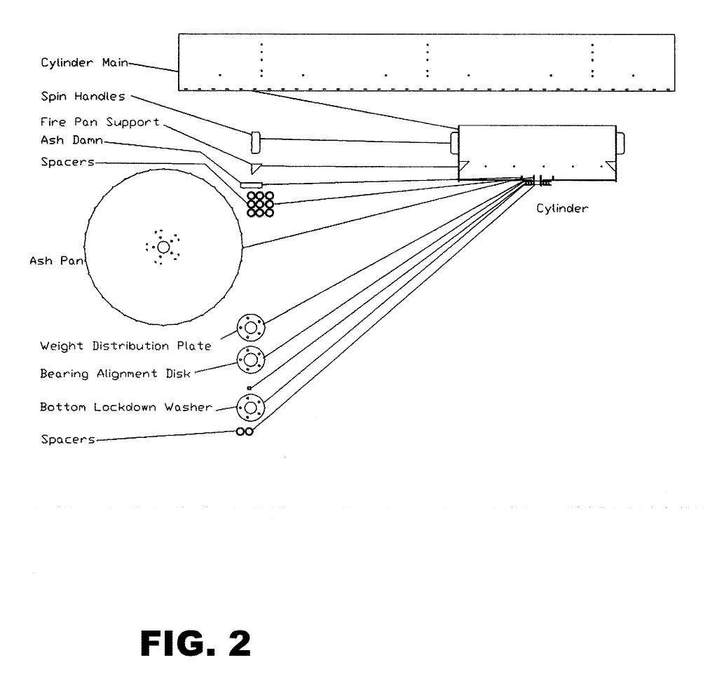

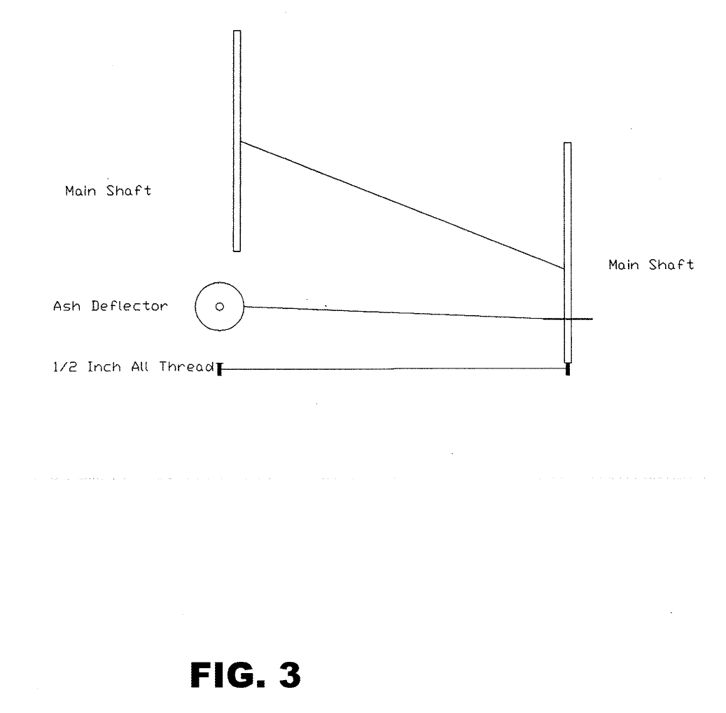

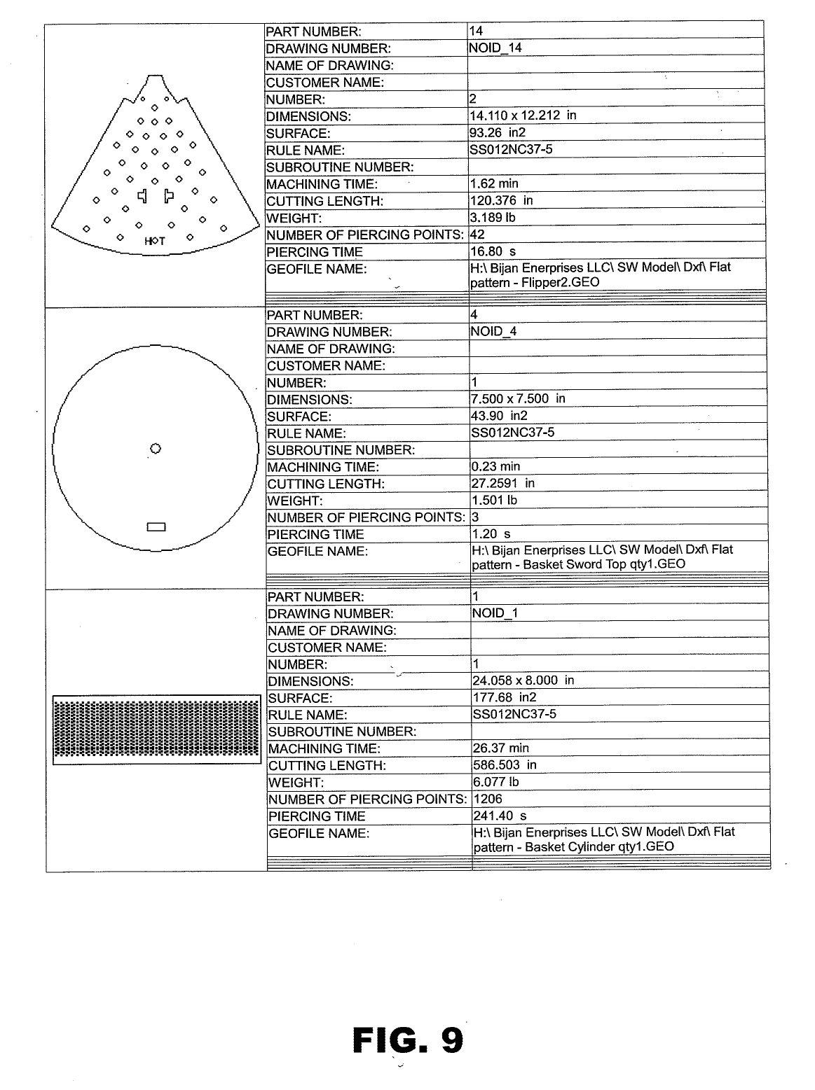

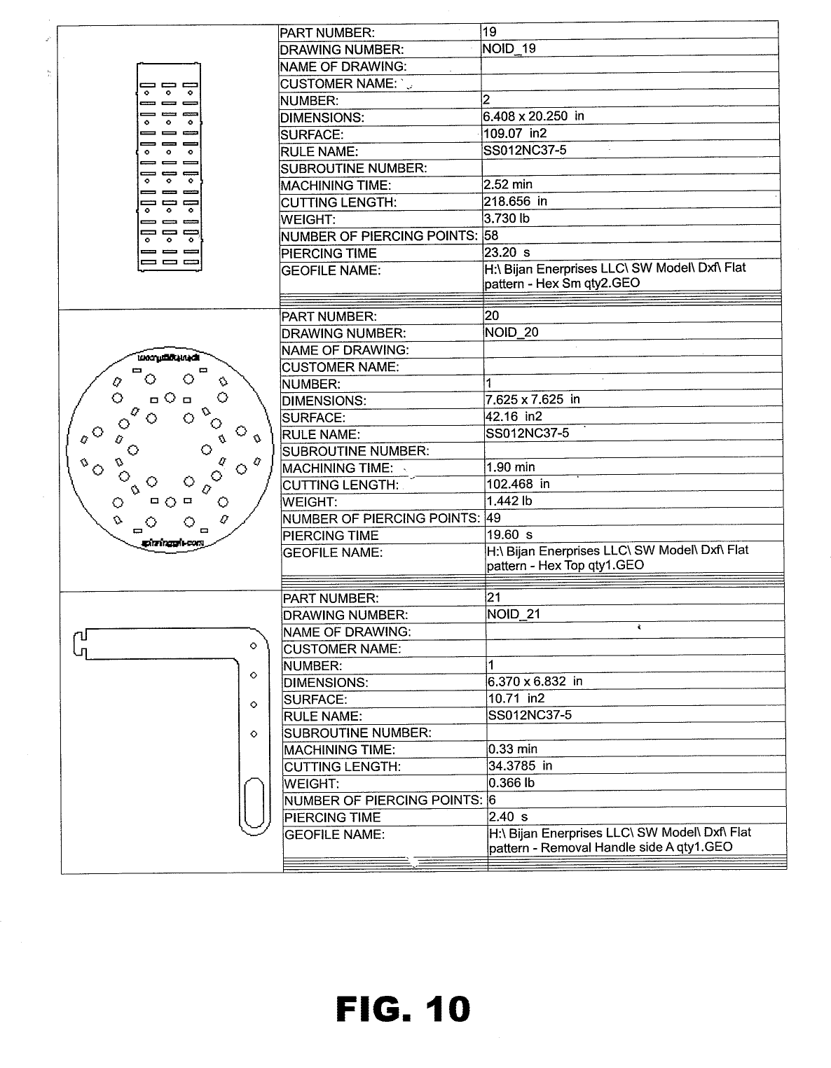

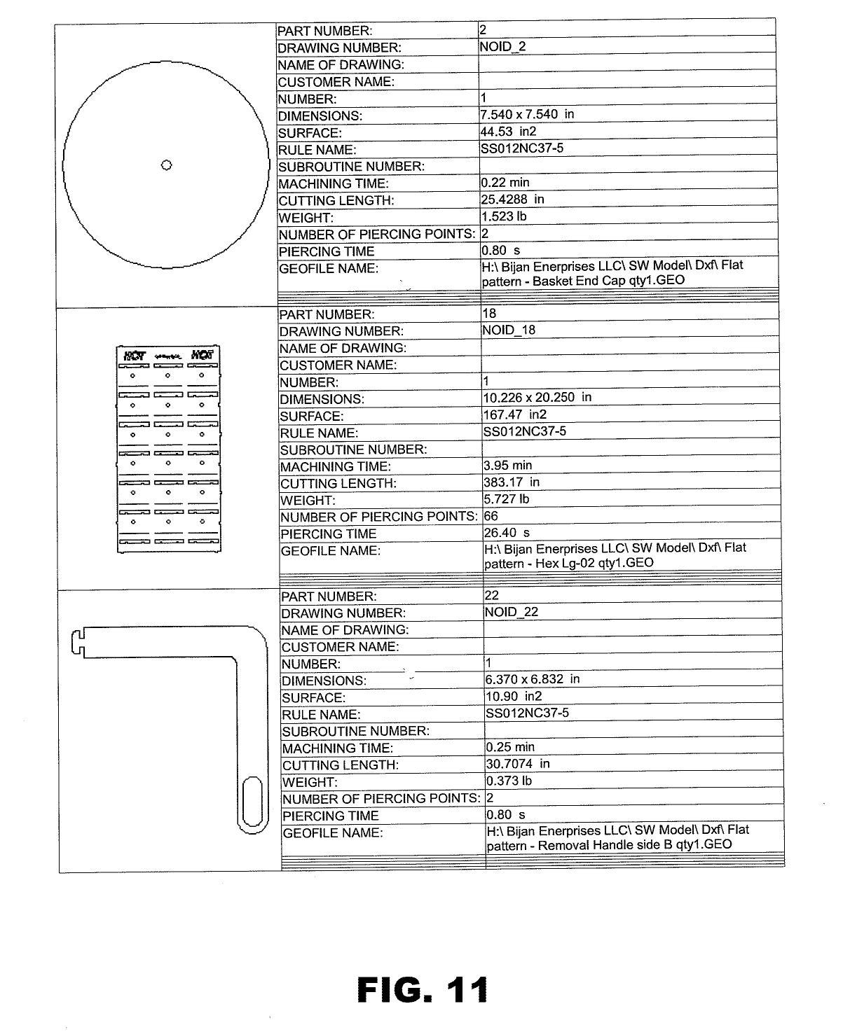

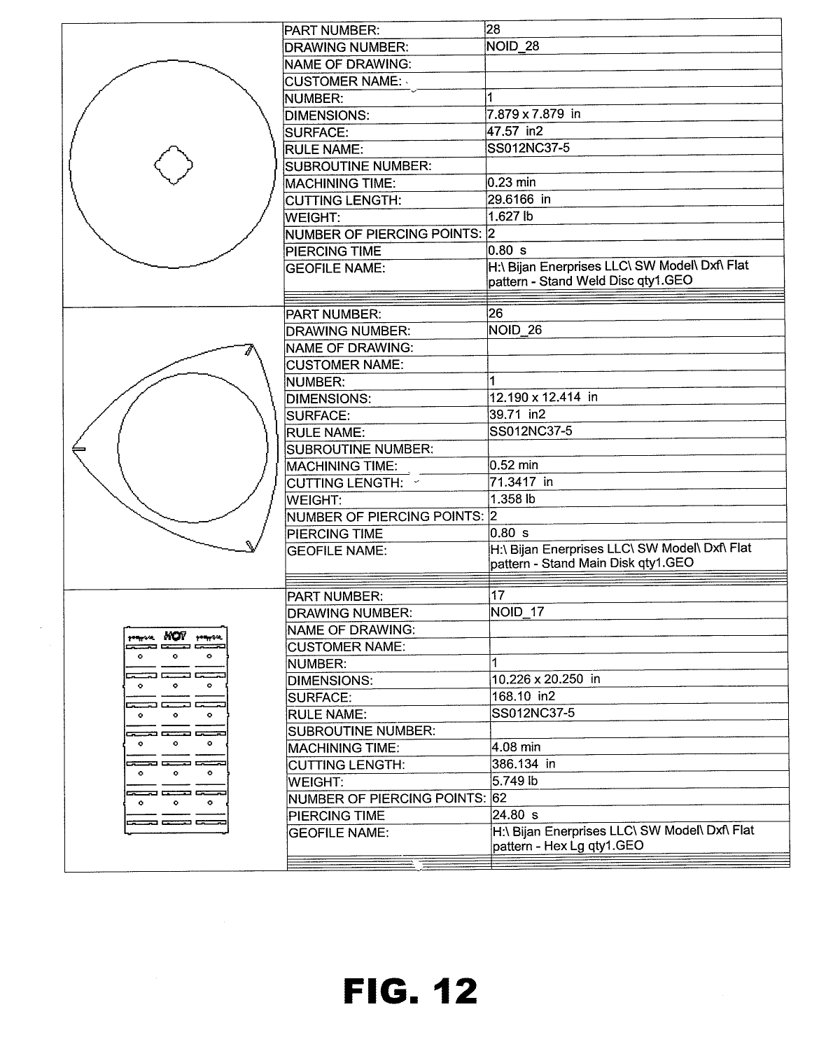

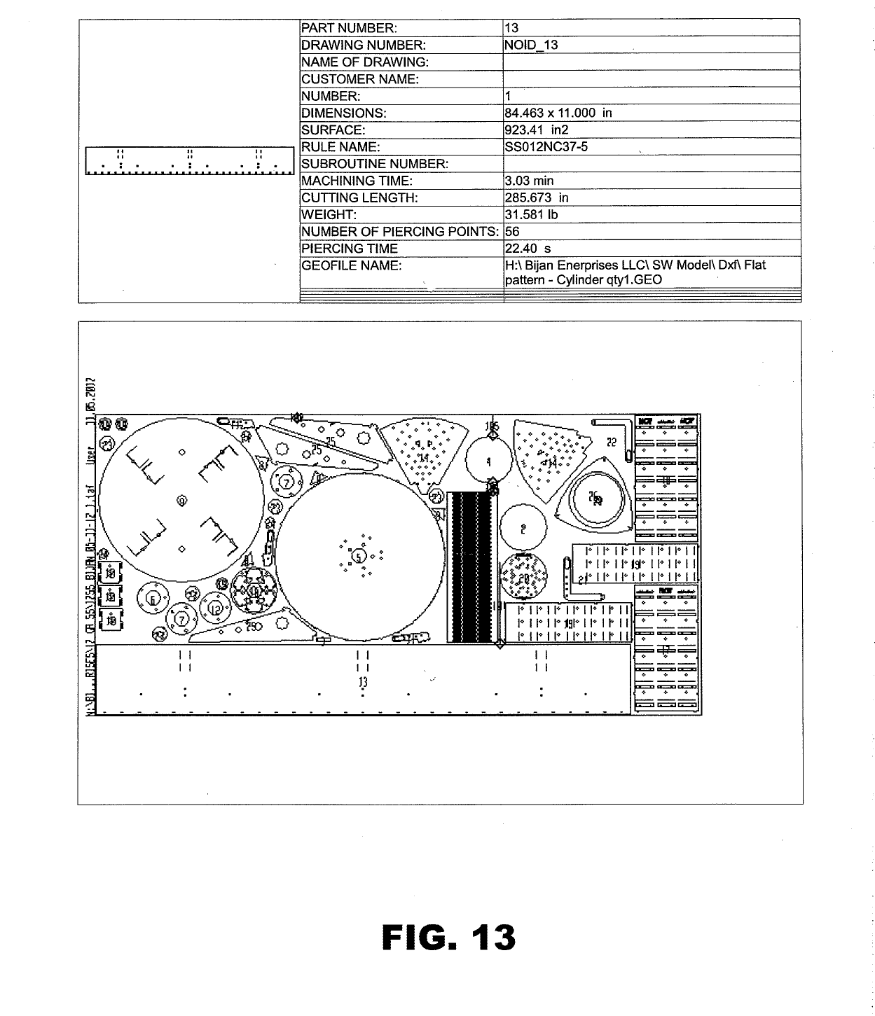

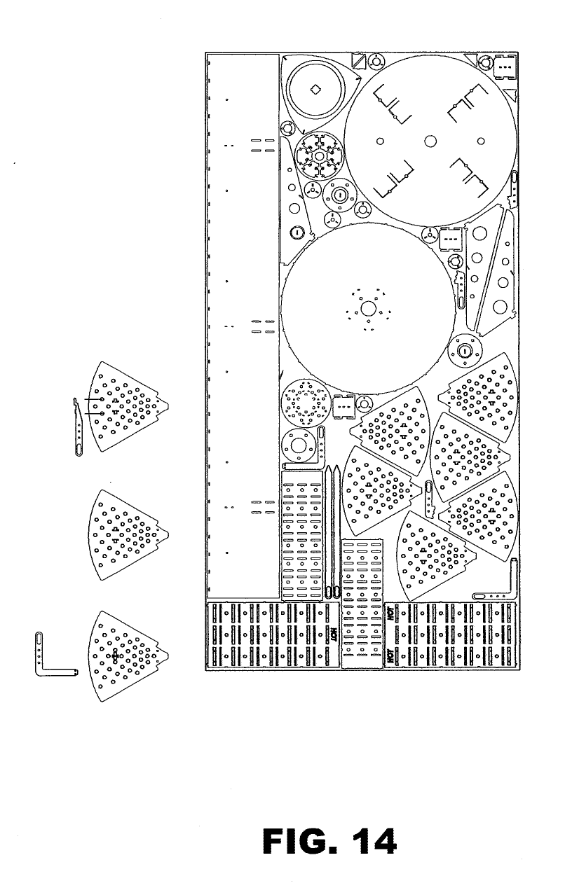

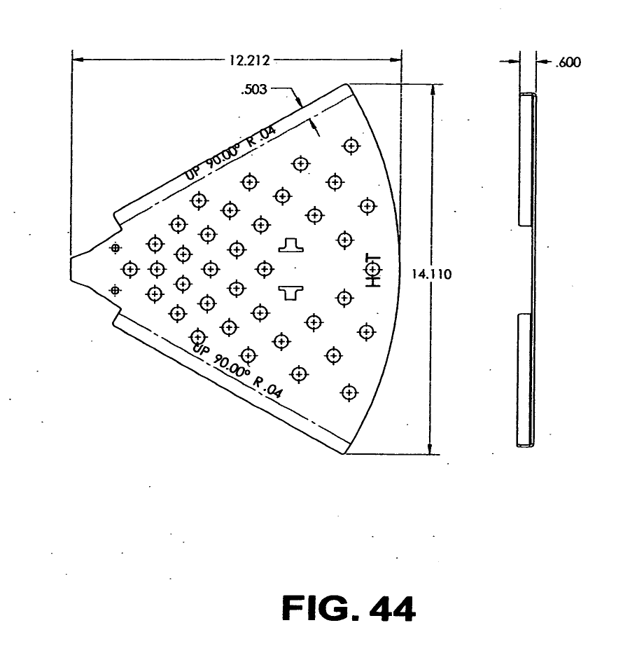

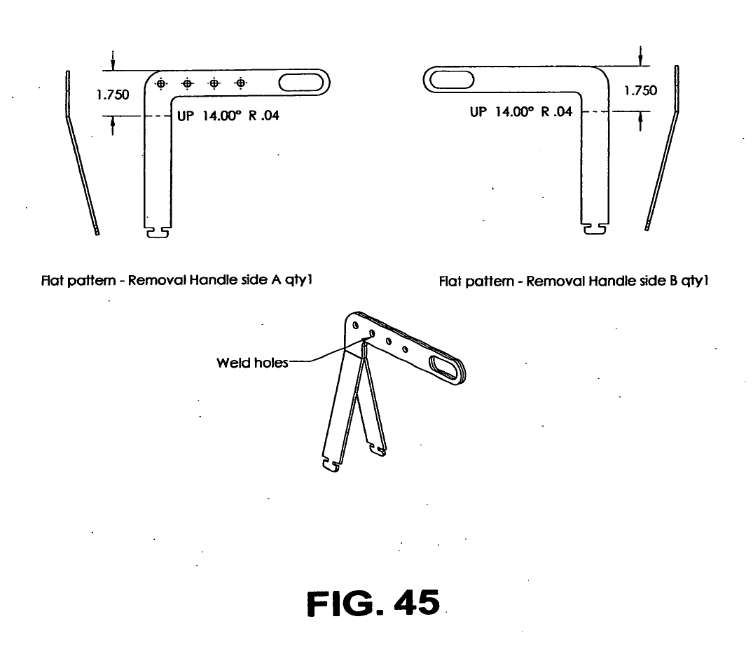

In some illustrative embodiments, another preferred type of attachment involves a “flipper” or grill plate attachment, such as, e.g., depicted in the illustrative examples shown in FIGS. 1, 5, 9, 13, 14, and 44 (wherein FIG. 44 shows both a top view and a distal end view of an illustrative flipper). In the preferred embodiments, the grill flipper can be inserted into the slots of the hexagonal Mounting Component and raised and/or lowered for different heats as may be necessary. By way of example, the flippers and placements of the flippers can be used for various meats (e.g., cooking at lower heights and raising for warming), warming breads, boiling water (e.g., within pots placed on the flippers) and/or any other use of a common grill or cooking surface.

In the preferred embodiments, an array of grill flippers can be placed side-by-side. In the preferred embodiments, the flippers can be arranged adjacent one another so as to increase the grilling surface at a certain level, such as, e.g., by placing two, three, four, five or even six flippers at the same level (e.g., in the illustrative preferred embodiments that employs a hexagonal mounting post). In the preferred embodiments, as best shown in FIG. 44, the sides of the flippers include raised flanges for enhancing rigidity. While flanges can be extended up or down in various embodiments, upward flanges also can help to retain product (e.g., food items, pots, etc.) upon the flippers during use.

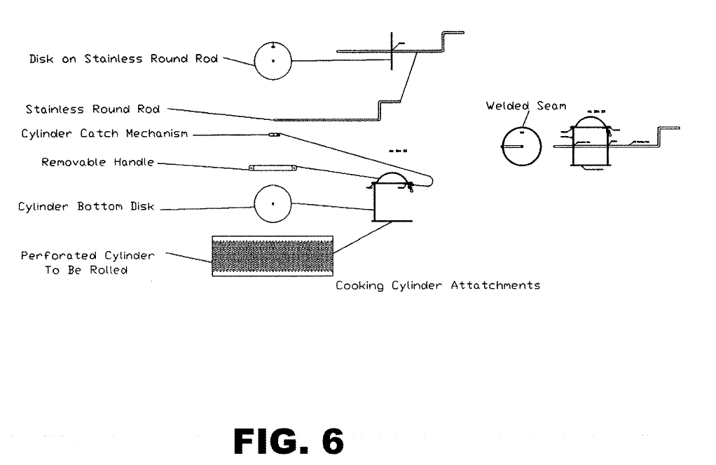

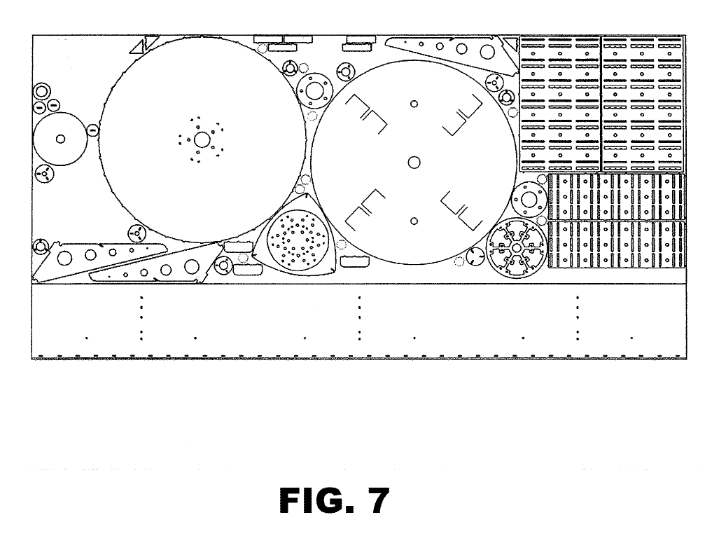

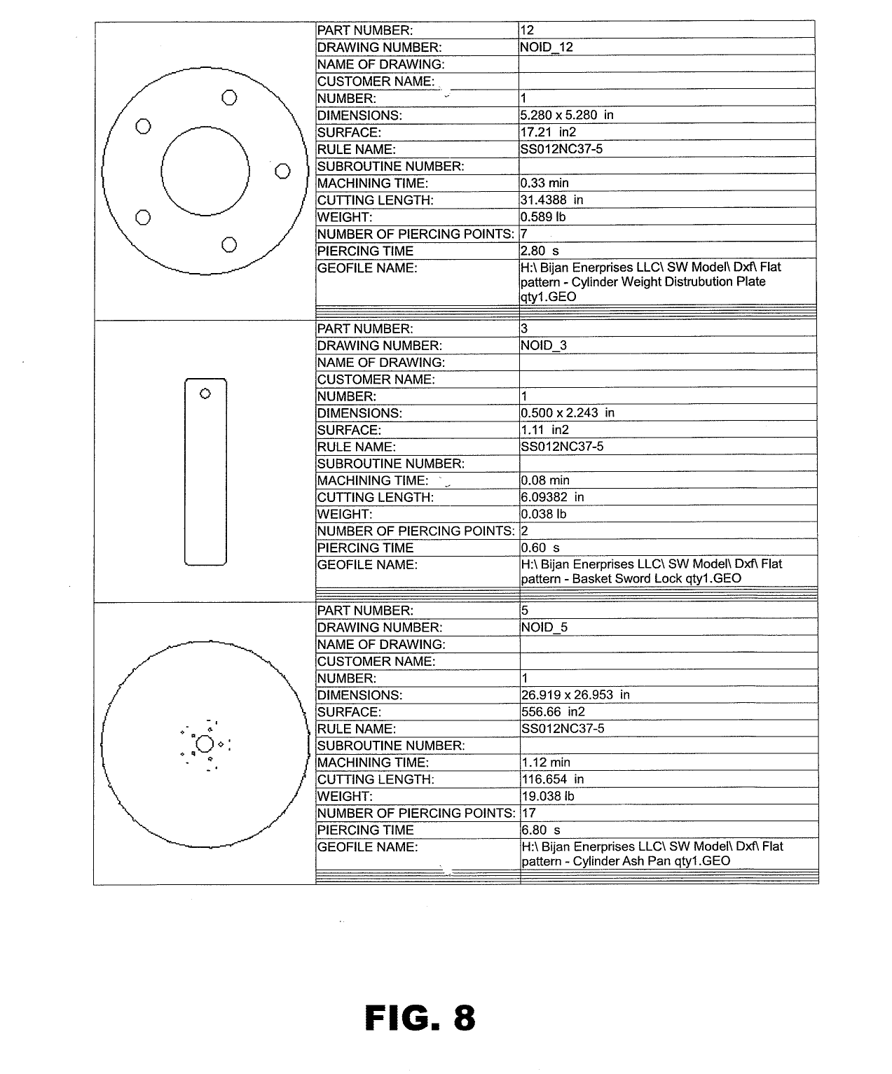

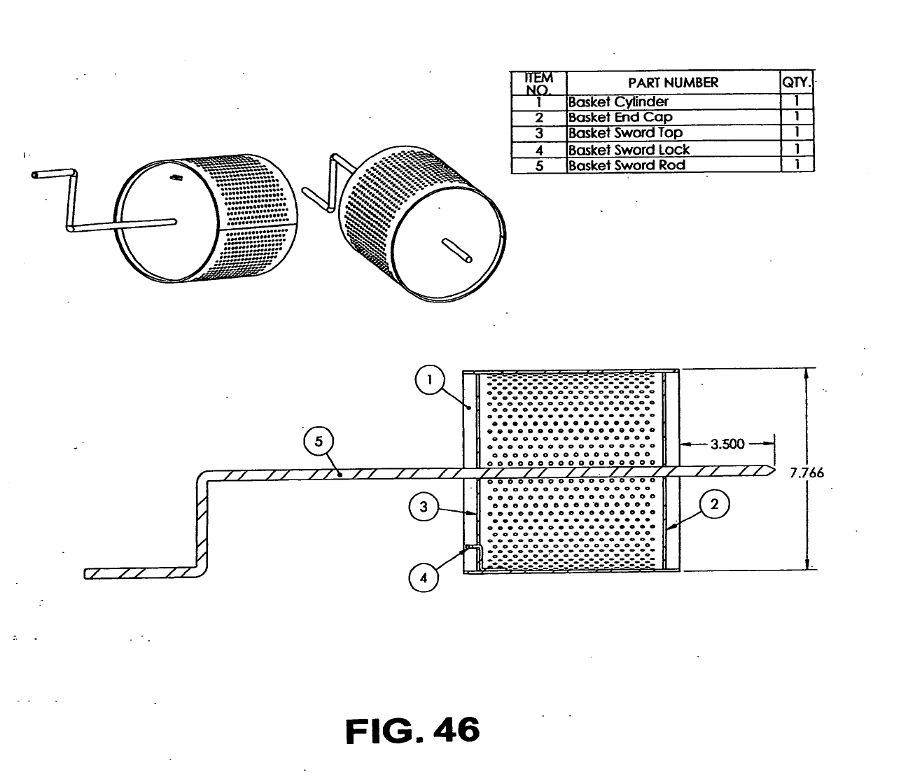

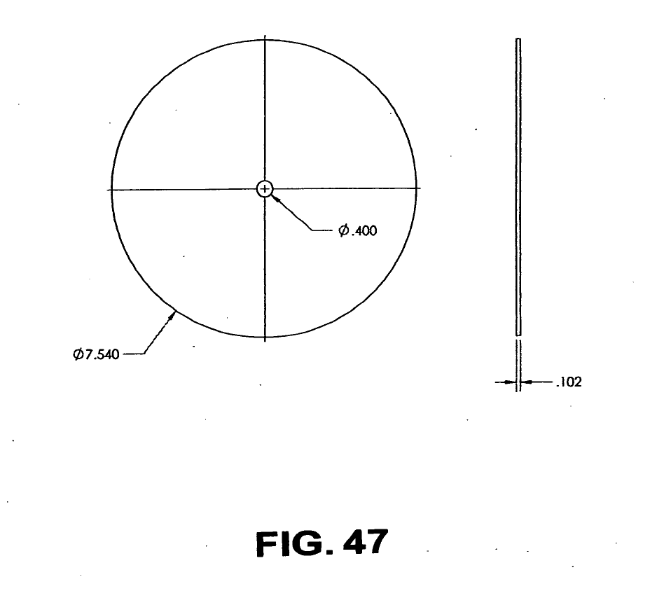

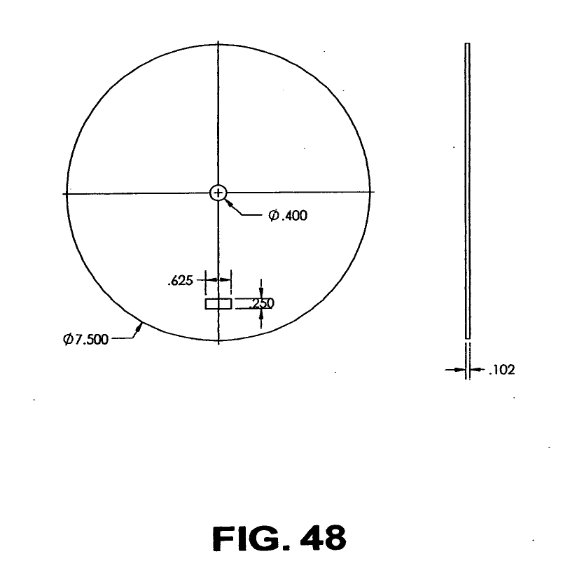

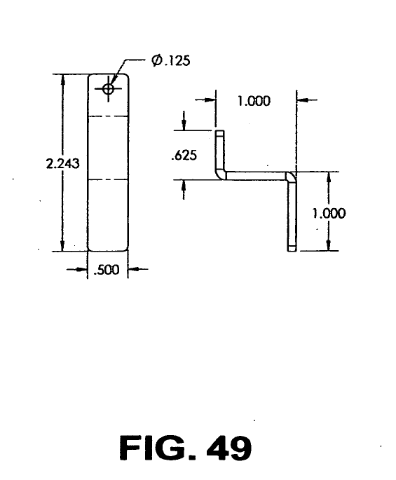

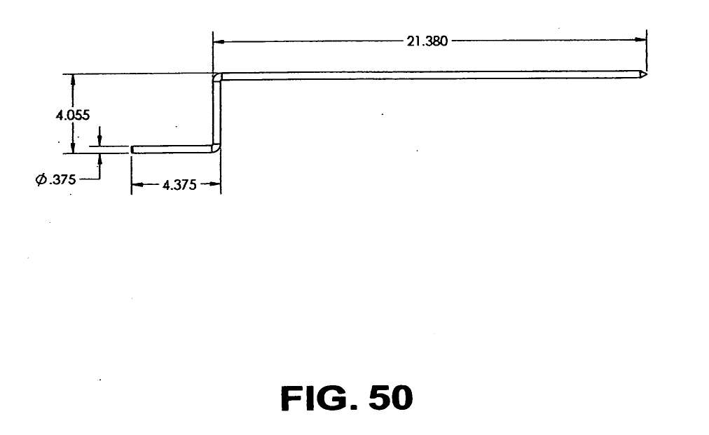

In some illustrative embodiments, another preferred type of attachment involves a novel “tumbler” cooker attachment, such as, e.g., depicted in the illustrative examples shown in FIGS. 1, 6, 15 and 46-50. In the preferred embodiments, the tumbler includes a perforated metal cylinder (preferably, made with stainless steel) that allows user to cook a variety of food items therein (e.g., either combined within a single tumbler or separated into different tumblers). In illustrative embodiments, the tumbler is made from 3 basic component parts. A first part is a perforated cylinder with a circular disk welded to a bottom end and clearance hole for a stainless rod to be inserted. In the preferred embodiments, the tumbler has an openable door (e.g., either one of the end caps can open or a side door of the perforated cylinder can open). In addition, the tumbler preferably also includes a lock or catch that retains the openable door in a locked position during use. In some preferred embodiments, with reference to FIG. 46, the rod 5 and the top disk 3 are welded together as a unitary piece, while the cylinder 1 and the bottom end cap 2 are similar welded together as another unitary piece. In use, the cylinder 1 and end cap 2 can be filled with food items (similar to filling a cup), and then the filled cylinder and end cap can be fitted to the rod and top cap (i.e., such that the rod extends thru an opening in the end cap and the top cap closes the top of the cylinder. Then, the lock 4 can fit within an opening in the top cap so as to retain the components together for cooking In some embodiments, the lock can comprise a flexible metal member that can be snap fit into a slot or hole in the top cap and manually disengaged to release the members when cooking is completed.

In some examples, the rod 5 is a stainless steel rod that is approximately 21 inches long with the disk 3 welded thereon and an offset handle portion. In operation, the extended distal end of the tumbler is fit within one of the circular holes of the Mounting Component and the tumbler can be readily rotated using the offset handle portion. In this manner, product within the tumbler can be rotated for optimal cooking Moreover, as with other attachments, the tumbler can be raised and/or lowered along the Mounting Component. During use, the holes within the tumbler cylinder also provide the advantageous use of enabling marinades or other sauces, additives, etc., to be introduced into the tumbler to enhance cooking In some embodiments, such can be introduced using a squeeze bottle which enables liquid marinades or the like to be injected through a small opening within the tumbler (e.g., similar to using a ketchup-style squeeze bottle), such as to add measurable flavors.

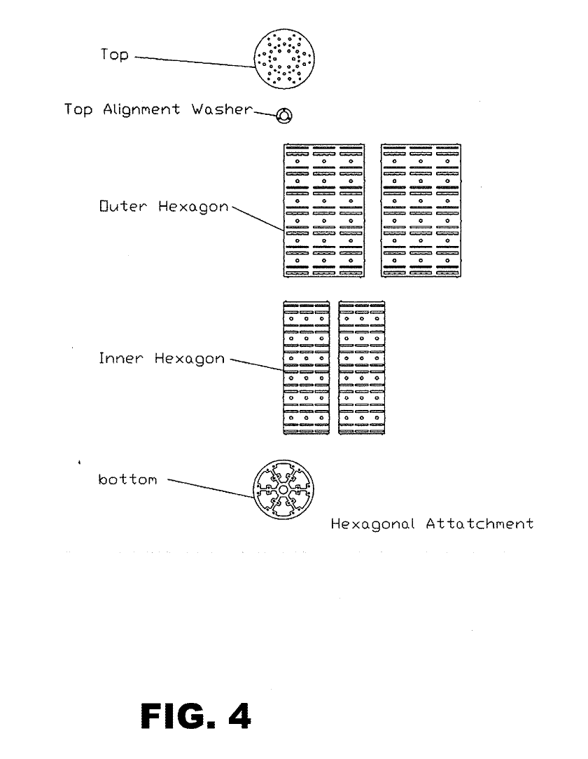

In some embodiments, the Mounting Component also includes a top alignment washer as shown in, e.g., FIG. 4, which can be fixed by welding to the inside of the top cap of the Mounting Component. Among other things, the alignment washer can be configured to receive the top end of the Main Shaft in order to ensure optimal alignment and/or to facilitate smooth rotationability of the Mounting Component around the Main Shaft. Although the Mounting Component is preferably rotatable around the Main Shaft, in the preferred embodiments a separate handle for grasping and rotating the Mounting Component is not provided. In such preferred embodiments, the Mounting Component can be readily rotated via any one of the attachment members (such as, e.g., skewers, tumblers, flippers, etc.). Moreover, in some embodiments, a user can rotate the Mounting Component by manually grasping the top end of the Mounting Component and rotating the same. Of course, in some embodiments, the Mounting Component can include one or more handle portion extending therefrom to facilitate grasping and rotating.

Although not shown, in some embodiments, the Mounting Component can include one or more temperature sensing thermometers thereon in order to provide a visual indication of temperature. In some embodiments, a plurality of thermometers can be provided so as to depict a variation in temperature above the fire pan at varied distances. In some embodiments, three or more thermometers can be provided along the height of the Mounting Component.

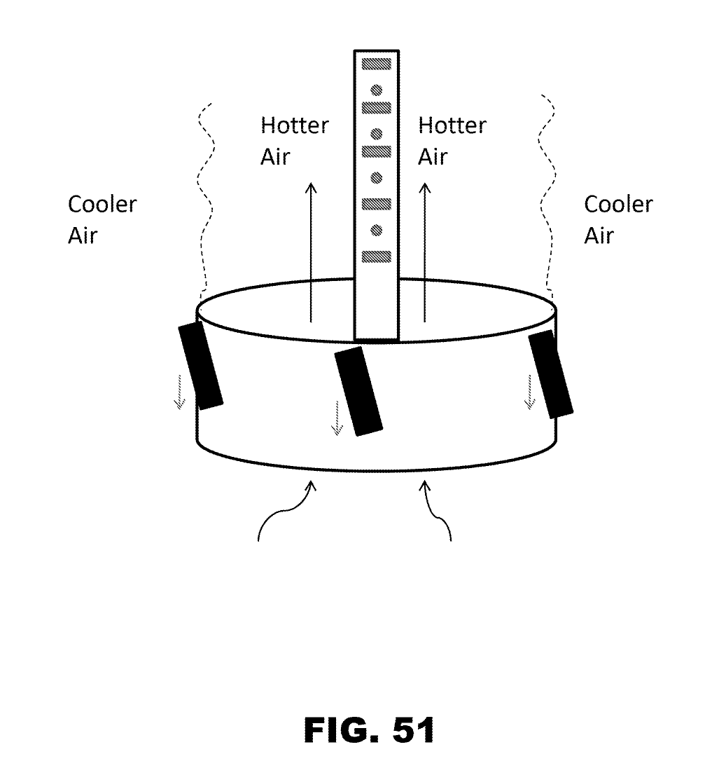

With reference to FIG. 51, the preferred embodiments of the invention provide rather unique and advantageous heat and air flows. First, as noted above, the rotation of the fire container enables the device to draw in air into the combustion fuel area so as to enhance lighting and maintaining of a cooking fire. Second, as noted above, the rotation of the fire container also enables cool air to be drawn within the fire container so as to protect components, especially the bearing from excessive temperatures. Additionally, the rotation of the container can also provide other heat and air flow advantages in some examples. In this regard, as depicted in FIG. 51 by drawing air upward into the fire container from below the fire pan, an upward air flow can be initiated which can cause hotter air to flow upward in a more columnar fashion than without such an air flow. As such, in some examples, the device can essentially cause the hotter air to be more centralized over the spinning grill as schematically shown in FIG. 51 (e.g., with hotter air being shown moving upwards with cooler air outside such hotter air). Additionally, in some embodiments, the rotation of the device can cause a whirlpool/spiral effect that can further cause hotter air over the spinning grill to be more centralized over the grill. Among other things, an increased centralization of the hotter air can help, in some circumstances, to reduce convection of heat away from food product being cooked or heated and/or to reduce directing of heat outward to users of the grill. In some embodiments, as shown in FIG. 51, the Container can even be modified so as to provide fins or the like so as to encourage a spirally air flow. By way of example, as shown, in some embodiments, handles that are used to rotate the container can be angled as fan blades to enhance flow of air either upwards along the outside perimeter and upward around the Container so as to enhance the separation of the cooler and hotter air or even downwards in some embodiments. In some embodiments, the direction of airflow can be modified based on the direction of the rotation of the Container.

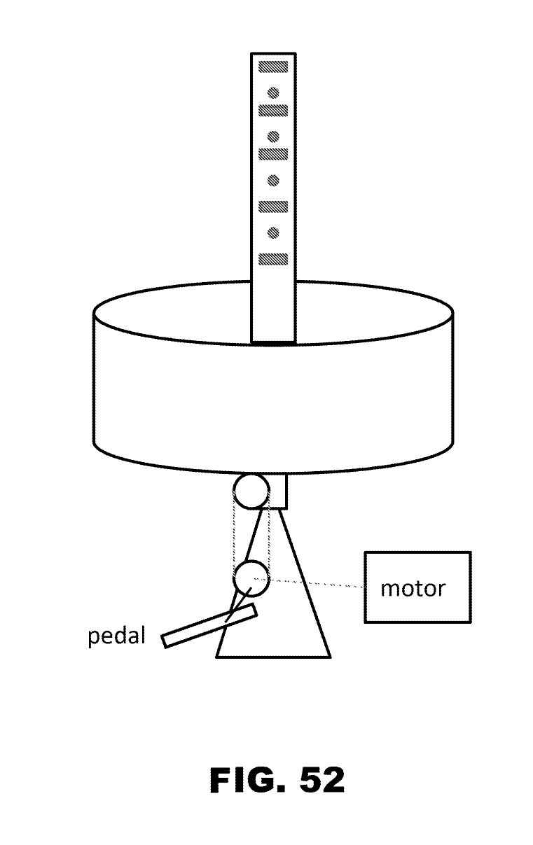

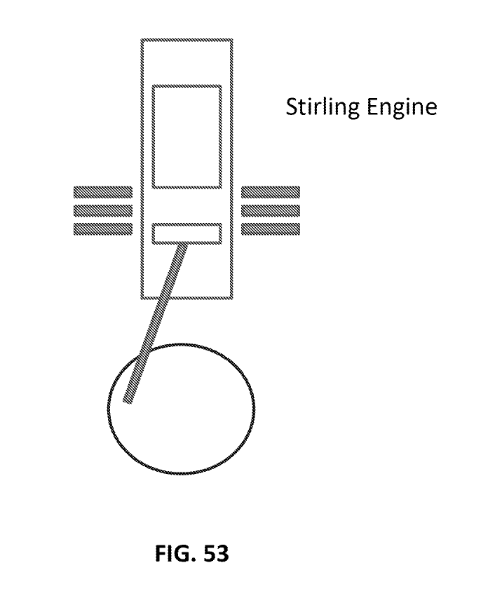

With reference to FIGS. 52-53, in some embodiments, rather than the Container merely being manually spun via a user grasping and handle and manually spinning the Container, the device can include a rotation mechanism to effect rotation. In some embodiments, the rotation mechanism can be human powered rotation mechanism (such as, e.g., employing a pedal, a hand crank or the like), an electric powered rotation mechanism (such as, e.g., an electric motor), a heat powered rotation mechanism (such as, e.g., a Stirling engine) or the like. In the illustrative example shown in FIG. 52, two optional rotation mechanisms are depicted. A first mechanism involves a foot pedal that is linked to a rotatable wheel or gear via a linkage such that repeated pressing of the pedal can cause the rotatable wheel or gear to rotate. The rotatable wheel or gear is connected via a chain or belt to another rotatable wheel or gear, which is situation so as to frictionally contact the bottom of the Container, whereby pedaling can cause continued rotation of the Container. A second mechanism involves a motor (shown in block form) which can include, e.g., an electric motor that is configured to drive the rotatable wheel or gear instead of the pedal. With reference to FIG. 53, in some embodiments, the heat of the fire within the fire pan can be utilized to cause or enhance rotation of the Container. Accordingly, in some embodiments, the rotation mechanism includes a heat to rotation device in order to effect rotational movement of the Container. In one illustrative and non-limiting example, the system can use a Stirling type engine as shown in FIG. 53, including a heated chamber (at the top caused by the fire within the fire pan), a piston and drive rod, etc., as shown, can be used so as to impart rotation to the wheel or gear.

In some alternative embodiments, although not shown rather than employing a natural combustion source such as wood, etc., the system can be modified so as to include a gas heat source. In that regard, a gas pipeline could be directed up through the stand and into the interior of the Container and can lead to rotated gas dispensing arms within the container. In order to effect rotation of the rotated gas dispensing arms the source of gas would need to come through a sealed joint that allows rotation of an upper section with respect to the lower section of the gas line. It should be appreciated that employing gas is a less desired embodiment.

### BROAD SCOPE OF THE INVENTION

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure, the following abbreviated terminology may be employed: “e.g.” which means “for example.”

What is claimed is:

1. A rotating grill, comprising:
a) a stand;
b) a container rotatably supported on said stand, said container being configured to support combustible material for creating a fire to cook food products;
c) a mounting component supported above said container, said mounting component being configured to support a grilling plate above said container upon which food products can be supported and grilled.

2. The rotating grill of claim 1, wherein said mounting component includes a plurality of holes or slots and said grilling surface is supported on said mounting component by fitting a portion of said grilling plate within said holes or slots.

3. The rotating grill of claim 2, wherein said plurality of holes or slots are vertically arranged such that the height of the grilling plate above said container can be adjusted.

4. The rotating grill of claim 3, further including a tool for grasping said grilling plate.

5. The rotating grill of claim 2, wherein said rotating grill includes a plurality of said grilling plates.

6. The rotating grill of claim 5, wherein said grilling plates are generally pie shaped.

7. The rotating grill of claim 5, wherein there are six of said grilling plates.

8. The rotating grill of claim 1, wherein said container is rotatably supported on said stand via a bearing.

9. The rotating grill of claim 8, wherein said container includes a lower compartment within which said bearing is located that is beneath a fire supporting surface of said container.

10. The rotating grill of claim 1, wherein said container includes holes and vanes configured to draw air into said container upon rotation of said container such as to enhance oxygenation and combustion within said container.

11. The rotating grill of claim 1, further including a handle for manually spinning the container on said bearings.

12. The rotating grill of claim 8, wherein said bearings are configured such that upon manual spinning of said container, said container spins for at least about 1 minute before coming to rest.

13. The rotating grill of claim 8, wherein said bearings are configured such that upon manual spinning of said container, said container spins for at least about 2 minutes before coming to rest.

14. The rotating grill of claim 1, including a human powered mechanism for spinning the container.

15. The rotating grill of claim 14, wherein said human powered mechanism includes a foot pedal, a hand crank and/or other mechanism for imparting human power.

16. The rotating grill of claim 1, further including a motor for causing rotation of said cylinder.

17. The rotating grill of claim 16, wherein said motor is electric, gas or heat powered.

18. The rotating grill of claim 1, wherein said mounting component is manually rotatable to a new location so as to adjust the angular position of said grilling plate over said cylinder to facilitate operation and use of the rotating grill.

19. The rotating grill of claim 1, further including a plurality of attachments that are attachable to said mounting plate.

20. The rotating grill of claim 19, wherein said attachments include one or more of the following: a) a skewer; and b) a rotatable basket.

21. The rotating grill of claim 1, wherein said container is made of stainless steel.

22. The rotating grill of claim 1, wherein said container, said mounting component and said grilling plate are made of stainless steel.

23. The rotating grill of claim 22, wherein said container, said mounting component and said grilling plate are all made of stainless steel and are all cut from a single sheet of stainless steel during fabrication.

24. A method of grilling food using a rotating grill, comprising:
a) rotating a container supporting combustible material creating a fire to cook food products;
b) having a mounting component support a grilling plate above said container upon which food products are supported and grilled.
